(19) United States
(12) Patent Application Publication
(10) Pub. No.: US 2013/0172184 A1
(43) Pub. Date: Jul. 4, 2013

(54) Plant Treatment Compositions and Methods for their Use

(71) Applicants: Oakford George Bain, Yuma, AZ (US); James Richard Brazzle, Sacramento, CA (US); Tak Wai Cheung, Yuma, AZ (US); Paul Joseph David, Lititz, PA (US); Brian Duane Deeter, Auberry, CA (US); John Edward Frieden, Kansas City, MO (US); Charles Paul Grasso, Yuma, AZ (US); Wallace Keith Majure, West Monroe, LA (US); David Alexander Marsden, Yuma, AZ (US); Gary Louis Melchior, Walla Walla, WA (US); Frank Rene Miranda, Holtville, CA (US); Kenneth Roger Muzyk, Brandon, FL (US); George David Newberry, Boise, ID (US); Nicholas William Vandervort, Cresco, LA (US); William Arthur Hendrickson, Stillwater, MN (US); Olaf Christian Moberg, New Brighton, MN (US); Susan Toddie Oeltjen, Lake Elmo, MN (US); Christopher John Rueb, St. Paul, MN (US)

(72) Inventors: Oakford George Bain, Yuma, AZ (US); James Richard Brazzle, Sacramento, CA (US); Tak Wai Cheung, Yuma, AZ (US); Paul Joseph David, Lititz, PA (US); Brian Duane Deeter, Auberry, CA (US); John Edward Frieden, Kansas City, MO (US); Charles Paul Grasso, Yuma, AZ (US); Wallace Keith Majure, West Monroe, LA (US); David Alexander Marsden, Yuma, AZ (US); Gary Louis Melchior, Walla Walla, WA (US); Frank Rene Miranda, Holtville, CA (US); Kenneth Roger Muzyk, Brandon, FL (US); George David Newberry, Boise, ID (US); Nicholas William Vandervort, Cresco, LA (US); William Arthur Hendrickson, Stillwater, MN (US); Olaf Christian Moberg, New Brighton, MN (US); Susan Toddie Oeltjen, Lake Elmo, MN (US); Christopher John Rueb, St. Paul, MN (US)

(73) Assignee: Gowan Comercio Internacional E Servicos Limitada, Funcha Madeira (PT)

(21) Appl. No.: 13/776,975

(22) Filed: Feb. 26, 2013

Related U.S. Application Data
(63) Continuation-in-part of application No. PCT/US2011/048748, filed on Aug. 23, 2011.
(60) Provisional application No. 61/377,618, filed on Aug. 27, 2010.

(51) Int. Cl. A01N 59/00

(52) U.S. Cl. 504/100; 504/101

(57) ABSTRACT

Plant treatment compositions comprising metal alginate salts and further containing at least one amine compound (sometimes also herein referred to as the “first amine compound”), and additionally includes at least a pH buffer composition comprising a second amine compound (sometimes also herein referred to as the “second amine compound”), which compositions useful in the treatment of plants, particularly food crops. In certain embodiments, the plant treatment compositions are highly effective even wherein the content of metallic copper present is 500 ppm or even less in the plant treatment composition used to treat plants or crops. The plant treatment compositions are found to be highly effective even in the absence of herbicides, fungicides and pesticides.

This is a continuation-in-part patent application filed under 35 USC 111(a) of copending international patent application PCT/US2011/048748, filed on 23 Aug. 2011, and claiming priority to U.S. 61/377,618 filed 27 Aug. 2010.

The present invention relates to plant treatment compositions and methods for their use. More particularly the present invention relates to plant treatment compositions comprising metal alginate salts as compositions useful in the treatment of plants, particularly food crops, methods for the production of such plant treatment compositions, and methods for their use.

The control of pathogentic fungi and bacteria and other diseases is of great economic importance since fungal growth on plants or on parts of plants inhibits production of foliage, fruit or seed, and the overall quality of a cultivated crop.

U.S. Pat. No. 5,977,023 discloses pesticidal compositions which necessarily include both a pesticide, and further necessarily include a pest-controlling active ingredient and/or a plant growth regulating active ingredient with a water insoluble alginate salt. The resultant compositions are granulated or pulvurent compositions which necessarily include both a pest-controlling active ingredient and/or a plant growth regulating active ingredient with the water insoluble alginate salt The compositions of U.S. Pat. No. 5,977,023 are prepared by treating a solid composition containing a pest-controlling active ingredient or a plant growth-regulating active ingredient and an alginic acid or a water-soluble alginate with an aqueous solution containing a divalent or polyvalent cation which can convert the alginic acid or water-soluble alginate into a water-insoluble alginate. Otherwise, the composition of the invention is prepared by coating a solid substance containing a pesticidally active ingredient which is a pest-controlling active ingredient or a plant growth-regulating active ingredient with a water-insoluble alginate. The function of the water-insoluble alginates are cited to impart controlled release, as well as sustained release properties of the pest-controlling active ingredient and/or a plant growth regulating active ingredient.

U.S. Pat. No. 2,983,722 discloses pesticidal compositions which include dual-metal salts depolymerized alginic acid, which depolymerized alginic acids are required in order form the dual-metal salts.

Published patent application US 2007/0010579 discloses certain copper salts of specific organic acids for use as fungicides. Such compositions may be used on plants or on inanimate substrates.

Although the prior art provides a wide variety of chemical compounds and chemical preparations or compositions which are useful as plant treatment compositions for the control of pathogentic fungi and bacteria and other diseases in plants and particularly plant crops, there nonetheless remains a real and urgent need for improved plant treatment compositions which provide such benefits, as well as further agriculturally relevant benefits. Likewise there remains a continuing need for improved methods for providing agriculturally relevant benefits to cultivated plants, e.g., preventive and curative fungicidal activity, for the protection of cultivated plants with a minimum of undesired side effects, and with relative safety for animals and humans.

It is to these and other objects that present invention is directed.

In a first aspect there are provided plant treatment compositions comprising metal alginate salts and further containing at least one amine compound (sometimes also herein referred to as the “first amine compound”), and additionally includes at least a pH buffer composition comprising a second amine compound (sometimes also herein referred to as the “second amine compound”), which compositions useful in the treatment of plants, particularly food crops.

In a second aspect there are provided methods for the production of plant treatment compositions comprising metal alginate salts, with at least one amine compound (sometimes also herein referred to as the “first amine compound”), and additionally includes at least a pH buffer composition comprising a second amine compound, which compositions are useful in the treatment of plants, particularly food crops.

A third aspect of the invention relates to methods for the treatment of plants, including food crops in order to control the incidence of and/or spread of pathogentic fungi and bacteria and other diseases in said plants and particularly food crops and providing improved plant health and/or food crop yields.

In a fourth aspect of the invention there are provided plant treatment compositions comprising metal alginate salts and further containing at least one amine compound (sometimes also herein referred to as the “first amine compound”), and additionally includes at least a pH buffer composition comprising a second amine compound, which compositions exhibit reduced phytotoxicity than many similar compositions, and wherein said compositions are useful in the treatment of plants, particularly food crops.

In a yet further aspect of the invention there are provided plant treatment compositions which are expected to be particularly useful in the treatment of plants and for controlling the incidence and spread of undesired pathogens therein, e.g., bacterial spot in tomato plants, such as may be caused by genus Xanthomonas, e.g, Xanthomonas campestris pv. vesicatoria; bacterial speck in tomato plants, such as may be caused by genus Pseudomonas e.g., Pseudomonas syringae PV tomato; late blight in tomato plants such as might be caused by Phytophthora infestans, citrus canker in citrus crops, such as may be caused by genus Xanthomonas e.g., Xanthomonas axonopodis pv. Citri; or fire blight on pome fruit, such as might be caused by Erwinia amylovora,

These and other aspects of the invention will be better understood from the following specification.

The present inventors have discovered that plant treatment compositions comprising metal alginate salt compositions and at least one amine compound and/or ammonia (also herein referred to as the “first amine compound”), and which additionally comprise at least a pH buffer composition comprising, or consisting of, a second amine compound (also herein referred to as the “second amine compound”), are particularly useful in the treatment of plants and/or fields, particularly food crops. Such plant treatment compositions have been observed to be surprisingly effective when provided in the absence of other biologically active materials, e.g., materials which exhibit or provide pesticidal, disease control, including fungicidal, mildew control or herbicidal or plant growth regulating effects. Such plant treatment compositions underscore the fact that metal alginate salt compositions are very effective when provided in the absence of other biologically active materials they are more attractive for use from an environmental standpoint due to their efficacy even in the absence of other biologically active materials. However these plant treatment compositions are expected to be useful when provided in conjunction with one or more of aforesaid biologically active materials, and in certain combinations may exhibit synergistic benefits therewith.

The plant treatment compositions of the invention may also include one or more non-biologically active materials which are recognized as being useful in the art.

The plant treatment compositions of the invention include one or more metal alginate salts which may be derived from reacting a metal, an inorganic and/or organic compound or species which releases a suitable metal ion, with an alginate in order to form the desired metal alginate salts, as well as one or more amine compounds selected from: ammonia, primary amines, secondary amines, tertiary amines, as well as salts thereof (viz, the “first amine compound”), and further the plant treatment compositions necessarily additionally comprise at least a pH buffer composition comprising, or consisting of, a second amine compound (viz., the “second amine compound”). The ammonia may be formed in-situ from a material or compound which releases or generates ammonia when combined with other constituents present in the plant treatment compositions, e.g. by reacting ammonium carbonate with water, or the ammonia may be provided as ammonia gas which is bubbled through the plant treatment compositions, or the ammonia, or for that matter any other form of the first amine compound as well as any form of the second amine compound may be introduced or provided to the plant treatment compositions by other means known to the art.

The plant treatment compositions of the invention necessarily include one or more metal alginate salts. The one or more metal alginate salts may be derived from or provided by reacting one or more compounds or complexes comprising the at least one metal selected from the elements represented on Groups 2-12, as well as any of the metals of Groups 13-15 of the Periodic Table of Elements (per IUPAC, 2000). These specifically include the transition metals of the Periodic Table of Elements. Particularly preferred are one or more metals selected from: magnesium, iron, copper, nickel, zinc, aluminum, palladium, cadmium, platinum, lead, and gold, but preferably the metal alginate salts are based on nickel, copper, zinc, aluminum, palladium, silver, or tin, and especially are based on copper. Chemical compounds which may dissociate when combined with water or a largely aqueous solvent to deliver monovalent and/or polyvalent free metal ions are particularly preferred, especially those which may deliver Cu(I), Cu(II), Ag(I), Ag(II) ions which are especially preferred. Especially preferred monovalent and/or polyvalent free metal ions are disclosed with reference to one or more of the examples, following.

Preferred embodiments of the plant treatment compositions of the invention need not include metal alginate salts of the plant treatment compositions which only comprise a single species of metals selected from magnesium, iron, copper, nickel, zinc, aluminum, palladium, cadmium, platinum, lead, and gold, preferably metal alginate salts based on nickel, copper, zinc, aluminum, palladium, silver, or tin, and especially those based on copper, but may contain a mixture of two or more different metals which are present as a part of the metal alginate salts, such as combinations of two or more of these metals, or even three of more of these metals in being simultaneously present.

It is also to be understood that according to preferred embodiments of the plant treatment compositions of the invention need not include metal alginate salts of the plant treatment compositions which only comprise a single species of metals selected from magnesium, iron, copper, nickel, zinc, aluminum, palladium, cadmium, platinum, lead, and gold, preferably metal alginate salts based on nickel, copper, zinc, aluminum, palladium, silver, or tin, and especially those based on copper, but may contain a mixture of at least one or more different metal species which are present as a part of the metal alginate salts, such as combinations of two or more of these metals, or even three of more of these metals concurrently with one or more non-metallic species such as calcium and/or sodium which may also be present. Accordingly in certain preferred embodiments, it is required that the recited metal alginate salts do necessarily include at least one metal, and may also contain at least one non-metal, but preferably do contain at least one non-metal concurrently with the at least one metal.

In certain embodiments, combinations of at least two different metals, or combinations which contain one or more different metals concurrently with one or more non-metals are preferred. Non-limiting examples of such preferred combinations include:

(A) a copper metal salt and at least one secondary metal salt at least selected from sodium, potassium, magnesium, calcium, barium, aluminum, manganese, iron, cobalt, nickel, copper, zinc, lead, silver, gold, cadmium, tin, palladium, platinum, gold and mixtures thereof;

(B) a silver metal salt and at least one secondary metal salt at least selected from sodium, potassium, magnesium, calcium, barium, aluminum, manganese, iron, cobalt, nickel, copper, zinc, lead, silver, gold, cadmium, tin, palladium, platinum, gold and mixtures thereof;

(C) copper(II) and calcium(II) salts, or copper(II) and zinc(II) salts, or copper(II) and silver(I) salts, or copper(II) and copper(I) salts, or copper(II) and sodium(I) salts, or copper(II) and sodium(I) and calcium(II) salts;

(D) silver(I) and calcium(II) salts, or silver(I) and zinc(II) salts, or silver(II) and silver(I) salts, or silver(I) and aluminum(III) salts, or silver(I) and sodium(I) and calcium (II) salts;

(E) a mixture of copper alginate and calcium alginate and/or a copper, calcium alginate;

(F) a mixture of copper alginate and zinc alginate and/or a copper, zinc alginate;

(G) a mixture of silver alginate and calcium alginate and/or a silver, calcium alginate;

(H) a mixture of silver alginate and zinc alginate and/or a silver, zinc alginate.

In certain preferred embodiments it is also contemplated that the metal alginate salt excludes non-metal salts, e.g., excludes sodium salts.

In still further embodiments it is contemplated the metal alginate salts necessarily include at least one metal, and at least one non-metals especially sodium or potassium salts which may be obtained from are sulfates, chlorides, nitrates, hydroxides, phosphates, carbonates, or mixtures thereof.

While not wishing to be bound by the following, the present inventors believe the presence of two or more metals, and/or the presence of at least one metal and one non-metal may provide for an ion exchange mechanism in the plant treatment compositions which may be beneficial.

The metal alginate salts of the invention may be formed by any conventional means which is currently known to the art, such as by combining metal cations with one or more alginates, e.g. alkali metal salts of alginic acid such as sodium alginate, calcium alginate and/or potassium alginate, silver salts of alginic acid, zinc salts of alginic acid, as well as ammonium salts of alginic acid, in order to form metal alginate salts. Non-limiting examples of divalent or polyvalent cations which can convert an alginic acid or alginate into a metal alginate salt are calcium cations, magnesium cations, barium cations, zinc cations, nickel cations, copper cations, (especially preferably those which provide Cu(I) and Cu(II) cations) silver cations (especially preferably those which provide Ag(I) and Ag(II) cations) and lead cations. Examples of particular aqueous solutions containing a cation include ones which contain calcium salts such as aqueous solutions of calcium chloride, calcium nitrate, calcium lactate, and calcium citrate, those containing magnesium salts such as aqueous solutions of magnesium chloride, magnesium nitrate, those containing barium salts such as aqueous solutions of barium chloride, those containing zinc salts such as aqueous solutions of zinc chloride, zinc nitrate, and zinc sulfate, those containing nickel salts such as aqueous solutions of nickel chloride, those containing copper salts such as aqueous solutions of copper sulfate, copper chloride, copper nitrate, copper oxychloride or any other chemical species which may be used to provide Cu(I) and especially Cu(II) cations in an aqueous composition. A particularly preferred copper salt is copper hydroxide. In such solutions, the content of the cation salt may be of any effective amount but advantageously is usually 1% by weight through saturated concentration, preferably 5% by weight through saturated concentration in aqueous solution.

Alginates may be based on alginic acids which may be generally represented by the structure:

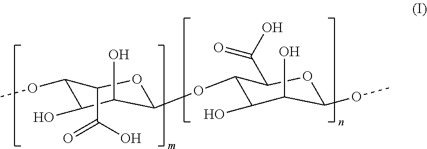

wherein m and n, independently are integers having values of sufficient magnitudes to provide a polymer of a suitable molecular weight. Typically, as indicated in formula (I) above, alginates are natural block copolymers extracted from seaweed and consist primarily (preferably essentially of, viz. contain at least 99.8% wt.) of uronic acid units, specifically 1-4-a, L-guluronic and 1-b, D-mannuronic acid which are connected by 1:4 glycosidic linkages. Such alginates are typically sold in a sodium salt form but different commercial grades may also contain varying amounts of other ions, including calcium ions. Examples of commercially available grades of alginates include those sold under one or more of the following tradenames: MANUTEX® including MANUTEX® RM (approx. molecular weight of 120,000-190,000) and MANUTEX® RD (approx molecular weight of 12,000-80,000), MANUGEL® including MANUGEL® GMB (approx. molecular weight of 80,000-120,000), MANUGEL® GHB (approx. molecular weight of 80,000-120,000), and MANUGEL® LBA, MANUGEL® DBP, KELTONE® including KELTONE® HV (approx. molecular weight of 120,000-180,000), KELTONE® LV (approx. molecular weight of 80,000-120,000), KELCOSOL® (approx. molecular weight of 120,000-190,000). Representative alginates having an excess of guluronic acid to mannuronic acid are MANUGEL® LBA, MANUGEL® DBP and MANUGEL® GHB wherein the ratio of guluronic acid units to mannuronic acid units are higher than a respective 1:1 ratio. Such are referred to as high guluronic alginates. MANUGEL® LBA, MANUGEL® DBP and MANUGEL® GHB have guluronic acid unit to mannuronic acid unit ratios of about 1.5:1. Representative alginates considered as low guluronic alginates, viz. those having a ratio of less than 1:1 of guluronic acid units to mannuronic acid units include KELTONE® HV and KELTONE® LV, which have guluronic acid unit to mannuronic acid unit ratios of about 0.6-0.7:1. In certain particularly preferred embodiments of the invention, high guluronic alginates are preferred for use in the plant treatment compositions.

The alginate can exhibit any number average molecular weight range, such as a high molecular weight range (about 2.05×10⁵ to about 3×10⁵ Daltons or any value therebetween; examples include MANUGEL® DPB, KELTONE® HV, and TIC 900 Alginate); a medium molecular weight range (about 1.38×10⁵ to about 2×10⁵ Daltons or any value therebetween; examples include MANUGEL® GHB); or a low molecular weight range (about 2×10 to about 1.35×10⁵ Daltons or any value therebetween; examples include MANUGEL® LBA and MANUGEL® LBB). Number average molecular weights can be determined by those having ordinary skill in the art, e.g., using size exclusion chromatography (SEC) combined with refractive index (RI) and multi-angle laser light scattering (MALLS).

Low-molecular through high-molecular weight alginates acids can be used in the compositions of the present invention, the molecular weight of the alginic acid or alginate is typically 500 through 10,000,000 Daltons, preferably 1,000 through 5,000,000 Daltons, and most preferably 3,000 through 2,000,000 Daltons. The alginic acid or alginate may be used in admixture of those having different molecular weights. Furthermore mixtures of two or more different alginates and/or metal alginate salts may also be used in the plant treatment compositions of the invention.

The amounts of metal alginate salts in the plant treatment compositions of the invention may vary widely and in part, depend upon the form of the product of the plant treatment compositions. Generally speaking the metal alginate salts may be provided in amounts of as little as 0.000001% wt. to as much as 100% wt (0.01 ppm to 1,000,000 ppm). of the plant treatment composition of which it forms a part. For example, higher concentrations are to be expected wherein the form of the plant treatment composition is a concentrate or super-concentrate composition which is provided to a user such as a plant grower with instructions to form a dilution in a liquid or solid carrier, e.g., water or other solvent, prior to application to plants. Lesser concentrations are expected wherein the plant treatment composition is provided as a ready-to-use product which is intended to be dispensed directly without further dilution from any container onto a plant. The plant treatment compositions of the invention may be applied “neat”, or may be first diluted in a larger volume of a suitable liquid carrier medium, e.g., water, and/or may be combined with one or more further biologically active constituents and/or non-biologically active constituents.

In preferred embodiments the concentration of metallic copper, viz, Cu(I) and/or Cu(II) (or Cu(I) and/or Cu(II) ions) in the plant treatment compositions of the invention in the final concentration or dilution wherein they are applied to crops, seeds, plants or plant parts is desirably 0.01 ppm-1000 ppm, but in increasing order of preference the concentration of metallic copper is not more than (in ppm): 950, 900, 850, 800, 750, 700, 650, 600, 550, 500, 575, 550, 525, 500, 475, 450, 425, 400, 375, 350, 325, 300, 290, 280, 270, 260, 250, 240, 230, 220, 210, 200, 190, 180, 170, 160, 150, 140, 130, 120, 110, 100, 90, 80, 70, 60, 50, 40, 30, 20, and 10 ppm. The inventors have surprisingly found that compositions with not more than 300 ppm, and even lesser amounts of not more than 100 ppm may in many instances provide a highly effective plant treatment composition, comparable or better in performance than commercially available preparations which exclude an alginate salt of a metal and in particular copper.

While not wishing to be bound by theory, it is believed that the presence of the first amine compound and the second amine compound of the pH buffer composition forms a complex with the metal cations which thus bind these metal ions and reduce the reactivity of the metal cations with the alginic acid or alginate until such time that, after application onto a plant or crop a major proportion of the liquid carrier, e.g., water, at least partially evaporates and thereafter the metal cations then form the desired metal alginate salts, in situ on the surface of the plant or crops being treated. The inventors have noted that the use of the amine compound, especially ammonia, readily complexes with the available monovalent and polyvalent metal ions, especially wherein such are Cu(I), Cu(II), Ag(I) or Ag(II) ions present, and in accordance with a preferred process of the invention, the plant treatment compositions are formed by at least a two step process wherein in a first step, one or more suitable sources of metal ions are contacted with one or more amine compounds in a suitable reaction medium, e.g., water or other solvent, in order to form a nitrogen containing metal complex, and thereafter in a subsequent process step the nitrogen containing metal complex is combined with the alginate, e.g., sodium alginate, calcium alginate and/or alginic acid, usually in a suitable reaction medium, e.g., water or other solvent, in order to form one form a preferred form of the plant treatment composition of the invention. Such a two step process may be used to form both concentrated forms of the plant treatment compositions of the invention, or may be used to form ready to use plant treatment compositions of the invention. Such also permits for providing the plant treatment compositions as two or more separate components or materials which are combined prior to, or on the plant, plant part or crop to form the plant treatment compositions of the invention. For example such may be attained by providing two or more separate compositions in a kit or package which are intended to be combined by the ultimate product user in order to form the plant treatment compositions.

As noted previously, in compositions of the present invention, a pH buffer composition comprising, or consisting of a second amine compound is also necessarily present, and particularly wherein the said second amine compound is an amine compound containing acetate, preferably ammonium acetate, is it hypothesized that when dissolved or dispersed in a carrier liquid, e.g., water, the amine compound becomes disassociated from the acetate during the formation of the metal salts of alginic acid and also take part in an ion exchange mechanism in the plant treatment compositions. It has also been unexpectedly observed that the presence of the second amine compound, particularly wherein such is an acetate complex of a nitrogenous compound, e.g., especially preferably ammonium acetate, that a significant safening benefit, viz., a reduction in the phytotoxicity of the final plant treatment compositions has been observed. This has been observed particularly wherein copper hydroxide is used to form the metal alginate salts, in the presence of both ammonium acetate which is useful a the pH buffer composition comprising the second amine compound, and wherein ammonia is present as the at least one amine compound and/or ammonia required of the inventive compositions. While not necessarily wishing to be bound by the following hypothesis, it is suspected that the presence of both the ammonia and the ammonium acetate forms a buffer to stabilize the pH at around 10. In addition, the acetate portion of ammonium acetate may serve some chelating function for calcium ions in hard water. Unexpectedly it has been observed that the foregoing benefits are not achieved to the same degree in compositions in which copper sulfate is used to form the metal alginate salts, and wherein a pH buffer composition comprising a second amine compound, particularly wherein said second amine compound is ammonium acetate, is omitted.

The pH buffer composition comprising, or consisting of, a second amine compound also contributes to maintain the pH of the plant treatment composition at or near a target pH, especially when the plant treatment composition is in a concentrated form prior to mixing in a larger volume of water to form a “tank mix” or dilution therefrom at an elevated pH of at least about 9, and preferably the pH of the plant treatment composition, especially when such is in a concentrated form is preferably in order of increasing preference at least: 9, 9.2, 9.4, 9.6, 9.8, 10, 10.2, 10.4 or higher. Preferably the pH of the plant treatment composition, especially when such is in a concentrated form does not exceed about 13, and is preferably in order of increasing preference not more than about 12.8, 12.6, 12.4, 12.2, 12, 11.8, 11.6, 11.4, 11.2 and 11, but is preferably less.

It is to be understood that the amine which may be provided by the first amine compound, and the amine which may be provided by the second amine compound of the pH buffer composition, may be the same amine compound(s) or may be different amine compounds. In certain particularly preferred embodiments the first amine compound is ammonia, and the pH buffer composition comprises or contains, preferably consists of, ammonium acetate which upon disassociation in water yields ammonia, thus both the first amine compound and the second amine compound are both ammonia.

In certain particularly preferred embodiments, the first amine compound is solely ammonia or a species, which in situ, forms or released ammonia in water.

In certain particularly preferred embodiments, the second amine compound is solely ammonium acetate.

In certain particularly preferred embodiments, the inorganic and/or organic compound or species which releases a suitable metal ion, is solely copper hydroxide.

In a particularly preferred embodiment the plant treatment compositions consist essentially of: copper hydroxide, ammonia or a species, which in situ, forms or released ammonia in water, but preferably, ammonia, ammonium acetate as the second amine compound of the pH buffer composition and preferably wherein the pH buffer composition is solely ammonium acetate, an alginate salt preferably sodium alginate, and water.

In a particularly preferred embodiment the plant treatment compositions consist of: copper hydroxide, as the first amine compound, ammonia or a species which in situ, forms or releases ammonia in water, but preferably, ammonia, and as the pH buffer composition, an acetate of a nitrogenous containing compound and preferably wherein the pH buffer composition is ammonium acetate, and especially preferably wherein the pH buffer composition is solely ammonium acetate, further, an alginate salt preferably sodium alginate, water, and optionally one or more biologically active materials and/or one or more non-biologically active materials.

In a particularly preferred embodiment the plant treatment compositions consist of: copper hydroxide, as the first amine compound, ammonia or a species which in situ, forms or releases ammonia in water, but preferably, ammonia, and as the pH buffer composition, an acetate of a nitrogenous containing compound and preferably wherein the pH buffer composition is ammonium acetate, and especially preferably wherein the pH buffer composition is solely ammonium acetate, further, an alginate salt preferably sodium alginate, water, and optionally may include one or more non-biologically active materials, with the proviso that the said compositions exclude one or more biologically active materials.

While it is clearly understood that the plant treatment compositions of the invention may be previously formed or formulated, e.g., weeks or months before actual use on a plant, plant part or crop, the plant treatment compositions may also be formed shortly before their application onto a plant, plant part or plant surface or crop, as well as may be formed directly upon the plant, plant surface or crop by providing a first composition containing the alginate or alginic acid preferably in a suitable carrier, e.g., water, and optionally including further constituents other than the first amine compound, the second amine compound and the inorganic and/or organic compound or species which releases a suitable metal ion, particularly Cu(I), Cu(II), Ag(I), Ag(II) cations, as well as also omitting the pH buffer composition comprising a second amine compound, and separately providing at least a second composition which contains the first amine compound and the pH buffer composition comprising a second amine compound and the inorganic and/or organic compound or species which releases a suitable metal ion, particularly Cu(I), Cu(II), Ag(I), Ag(II) cations, preferably in a suitable carrier, e.g., water, and which optionally contains further constituents, and combining the said first composition with said at least second composition to form the plant treatment composition shortly prior to application onto a plant, plant surface or crop, or alternately, applying the said first composition and the at least said second composition separately but simultaneously, or applying them sequentially to a plant, plant surface, or crop, such that the desired metal alginate is formed in situ, directly upon the plant, plant surface or crop. Such an application process provides for the practice of the invention according to processes wherein the inorganic and/or organic compound or species which releases a suitable metal ion, particularly Cu(I), Cu(II), Ag(I), Ag(II) cations is physically separated from the alginic acid or alginate salt (e.g., sodium alginate salt, calcium alginate salt) until just shortly prior to application, e.g., such as may be practiced by providing a first composition and at least second composition outlined above to tank containing one or more further constituents but especially a carrier, e.g., water, in order to form the plant treatment composition directly in the tank and just before application to plants or crops, such as by spraying. Alternately such an application process provides for the practice of the invention according to processes wherein the said first composition and at least said second composition may be separately provided by spray apparatus as two distinct streams which are mixed at the inlet of, or within a nozzle of a sprayer. Alternately such an application process also provides for the practice of the invention according to a process wherein said first composition is separately applied, such as by spraying, onto a plant, plant surface or crop, and thereafter said at least second composition is applied, such as by spraying, onto a plant, plant surface or crop, such that the first composition and the at least second composition mix on the surface of the plant, or on the crop to which both compositions have been applied. The mixing on the surface of the plant or crop permits for the in situ formation of the metal alginate salt, preferably the preferred Cu(I), Cu(II), Ag(I), Ag(II) cations. These processes may also be advantageously practiced by reversing the order of addition of, or the application of, the said first and said second compositions, e.g, by applying the second composition prior to tank mix, or to the plant or crop, followed by application of the first composition as the order of addition or that of application is not critical, rather it is only required that the alginic acid or alginate salt be kept separate from the inorganic and/or organic compound or species which releases a suitable metal ion, particularly Cu(I), Cu(II), Ag(I), Ag(II) cations, until shortly prior to application onto a plant, plant surface or crop.

In a further aspect of the invention there are provided plant treatment compositions which may be formed directly on the plant, plant surface or crop by providing a first composition containing the alginate or alginic acid preferably in a suitable carrier, e.g., water, and optionally including further constituents other than the inorganic and/or organic compound or species which releases a suitable metal ion, particularly Cu(I), Cu(II), Ag(I), Ag(II) cations, and separately providing a second composition which contains the inorganic and/or organic compound or species which releases a suitable metal ion, particularly Cu(I), Cu(II), Ag(I), Ag(II) cations, preferably in a suitable carrier, e.g., water, and which optionally contains further constituents, and combining the said first composition with said second composition to form the plant treatment composition shortly prior to application onto a plant, plant surface or crop, or alternately, applying the said first composition and the said second composition sequentially to a plant, plant surface, or crop, such that the metal alginate is formed in situ, directly upon the plant, plant surface or crop. Due to the physical separation of the first composition from the second composition until shortly prior to application onto a plant, plant surface or crop, the inventors have found that the amine compounds are not required and may be omitted. Such an application process provides for the practice of the invention according to processes wherein the inorganic and/or organic compound or species which releases a suitable metal ion, particularly Cu(I), Cu(II), Ag(I), Ag(II) cations is physically separated from the alginic acid or alginate salt (e.g., sodium alginate salt, calcium alginate salt) until just shortly prior to application, e.g., such as may be practiced by providing a first composition and a second composition outlined above to tank containing one or more further constituents but especially a carrier, e.g., water, in order to form the plant treatment composition directly in the tank and just before application to plants or crops, such as by spraying. Alternately such an application process provides for the practice of the invention according to processes wherein the said first composition and said second composition may be separately provided by spray apparatus as two distinct streams which are mixed at the inlet of, or within a nozzle of a sprayer. Alternately such an application process also provides for the practice of the invention according to a process wherein said first composition is separately applied, such as by spraying, onto a plant, plant surface or crop, and thereafter said second composition is applied, such as by spraying, onto a plant, plant surface or crop, such that the first composition and the second composition mix on the surface of the plant, or on the crop to which both compositions have been applied. The mixing on the surface of the plant or crop permits for the in situ formation of the metal alginate salt, preferably the preferred Cu(I), Cu(II), Ag(I), Ag(II) cations. These processes may also be advantageously practiced by reversing the order of addition of, or the application of, the said first and said second compositions, e.g, by applying the second composition prior to tank mix, or to the plant or crop, followed by application of the first composition as the order of addition or that of application is not critical, rather it is only required that the alginic acid or alginate salt be kept separate from the suitable metal ion, particularly Cu(I), Cu(II), Ag(I), Ag(II) cations until shortly prior to application onto a plant, plant surface or crop.

In the foregoing outlined processes, it is to be understood that the clause “shortly prior to application onto a plant, plant surface or crop” is to be understood in the context that the first said composition and the second said composition are combined with one another, optionally with one or more further constituents but preferably within a suitable carrier, not more than 24 hours, preferably not more than 18 hours, and in order of increasing preference, not more than 12 hours, 10 hours, 8 hours, 6 hours, 5 hours, 4 hours, 3 hours, 2 hours, 1 hour, 0.75 hour, 0.5 hour, 0.25, 0.1 hour, and 0.05 hour prior to dispensing by a suitable or conventional means or device, e.g., sprayer, and onto a plant, plant part or crop. In the foregoing outlined processes, wherein a first composition is applied to a plant by a first application step, followed by a separate application of the second composition in a second application step, preferably the time interval between the said first application step and the second application step is not more 6 hours, preferably not more than 4 hours, and in order of increasing preference, not more than 3 hours, 3.5 ours, 2 hours, 2.5 hours, 2 hours, 1.5 hours, 1 hour, 0.75 hour, 0.5 hour, 0.25 hour, and especially preferably not more than 0.1 hour. Particularly advantageously the said first application step and the second application step are practiced not more than 5 minutes apart, and in a particularly preferred process embodiment the said first composition and the second composition are either separately but simultaneously delivered from separate supply means, e.g., spray nozzles or jets, onto plants, plant surfaces or crops wherein the said first composition and second composition mix, or in a further particularly preferred process embodiment the said first composition and the second composition are separately supplied from separate supply sources to supply means, e.g., spray nozzles or jets, and are mixed immediately prior to being supplied to the supply means, or are mixed within the supply means such that the mixture of first composition and the second composition occurs not more than 15 seconds, preferably not more than 10 seconds, still more preferably and in order of increasing preference: not more than 8 seconds, 7 seconds, 6 seconds, 5 seconds, 4 seconds, 3 seconds, 2 seconds, 1 second, 0.5 second, before being delivered from the supply means and onto plants, plant surfaces or crops.

The plant treatment composition of the invention may also be formed by combining the first composition with the at least second composition, optionally with further constituents, e.g., a liquid carrier in a suitable mixing and/or storage vessel, such as a tank if to be applied shortly after mixing or in a storage tank if to be applied at a later date. Advantageously the plant treatment composition of the invention may also be formed by combining the first composition with the at least second composition, optionally with further constituents, e.g., a carrier shortly prior to application onto a plant, plant surface or crop. Mixing need not occur on the surface of the plant, or on the crop or prior to the nozzle or within the nozzle or spray head as outlined above.

Advantageously, the final end-use concentration of the one or more metal alginate salts in the plant treatment compositions, viz., the concentration of the one or more metal alginate salts in the plant treatment compositions which are in the form as applied to seeds, plants or for that matter soil, are those which are found to be effective in the treatment of a particular plant or crop, which amount is understood to be variable, as it may be affected by many factors, including but not limited to: type of plant or crop treated, treatment dosages and application rates, weather and seasonal conditions experienced during the plant or crop growing cycle, etc. Such variables are which are commonly encountered by and understood by the skilled artisan, who may make adjustments to the treatment regimen, e.g., application rate, and/or application timings and/or application frequencies. Advantageously the concentration of the one or more metal alginate salts in such end-use plant treatment compositions can be such to provide as little as 0.01 ppm, to 500,000 ppm of the metal ion(s) used to form the metal alginate salt, but preferably are between 0.01 ppm and 100,000 ppm of the metal ion(s) used to form the alginate salt, yet more preferably is between 1 ppm and 10,000 ppm of the metal ion(s) used to form the alginate salt, as applied to the plant or alternately as present in an end-use concentration such as a ready to use or ready to apply composition intended to be applied to a plant, plant part or crop. Surprisingly the inventors have found that the metal alginate salts of the plant treatment compositions in such final end-use concentrations or as applied to a plant concentration are effective in the treatment of plants in amounts which are typically less, and frequently far less than the concentration of the active amounts of conventional pest-controlling active ingredient and/or a plant growth-regulating active ingredient, viz., herbicidal, fungicidal or pesticidal compounds based on a metal ion(s) or metal salt(s) which are necessary in order to provide a comparable benefit level. Preferably the plant treatment compositions of the invention thus contain from about 0.5 ppm to 500,000 ppm, preferably from about 1 ppm to about 50,000 ppm and especially preferably from about 1 ppm to about 25,000 ppm of the metal ion(s) used to form the metal alginate salt being provided by the plant treatment composition, in the form as applied to the plant, plant part or crop. In certain particularly preferred embodiment the plant treatment compositions thus contain from about 0.5 ppm to about 25,000 ppm and in order of increasing preference not more than: 24,000 ppm, 23,000 ppm, 22,000 ppm, 21,000 ppm, 20,000 ppm, 19,000 ppm, 18,000 ppm, 17,000 ppm, 16,000 ppm, 15,000 ppm, 14,000 ppm, 13,000 ppm, 12,000 ppm, 11,000 ppm, 10,000 ppm, 9,000 ppm, 8,000 ppm, 7,000 ppm, 6,000 ppm, 5,000 ppm, 4,000 ppm, 3,000 ppm, 2,000 ppm. and 1,000 ppm, 900 ppm, 800 ppm, 700 ppm, 600 ppm, 500 ppm, 400 ppm, 300 ppm, 200 ppm or even less in certain embodiments. Reference is made to the example compositions which demonstrate certain particularly preferred inventive plant treatment compositions.

The inventors expect and believe that the use of the metal alginate salts permits for the application at lower rates than certain metal-based commercial products (e.g., KOCIDE, ex. E.I. DuPont de Nemours), as it is believed that the applied coverage of the product permits for a more uniform, and more complete application permits for the improved deposition and retention of the compositions on plant surfaces.

The inventors expect that the metal alginate salts, particularly those based on copper salts, may show surprisingly good efficacy against certain copper resistant strains or pathogens on plants, which has not been effectively treated by prior art commercially available preparations, e.g. KOCIDE® 2000, KOCIDE® 3000, and Cuprofix® Ultra. It is expected that such salts based on or including other metals, especially silver, are also expected to provide good results.

Contrary to U.S. Pat. No. 5,977,023, the present inventors have discovered that their plant treatment compositions provide an effective treatment composition for control undesired plant diseases, e.g., pathogentic fungi and bacteria and/or other diseases in plants and particularly plant crops even in the absence of a pest-controlling active ingredient and/or a plant growth-regulating active ingredient. In certain preferred embodiments of the plant treatment compositions of the invention, such pest-controlling active ingredients and/or plant growth-regulating active ingredients are absent and are excluded from the plant treatment compositions of the invention.

Copper alginate salts are found to be economically feasible, and have been proven to be effective as is disclosed in one or more of the examples illustrated below. Further useful alginate salts are discussed following. However, the use of other metals or metallic cations although not expressly demonstrated in one or more the following examples is nonetheless is contemplated to be within the scope of the present invention.

As noted above, the plant treatment compositions include one or more amine compounds, viz. “first amine compound”, selected from: ammonia, primary amines, secondary amines or tertiary amines, as well as salts thereof. By way of non-limiting example, exemplary primary amines include methylamine, ethanolamine; exemplary secondary amines include dimethylamine, diethylamine, and cyclic amines such as aziridine, azetidine, pyrrolidine and piperidine; exemplary tertiary amines include trimethylamine. Further amines include ethylenediamine, diethyeneltriamine, triethylenetetramine, tetraethylenepentamine, piperazine, aminoethylpiperazine, aminoethylethanolamine, hydroxyethylpiperazine, methyldiethylenetriamine. Such amine compounds include those which would form a complex with the one or more compounds or complexes comprising the at least one metal selected from the elements represented on Groups 2-12, as well as any of the metals of Groups 13-15 of the Periodic Table of Elements ultimately used in the formation of the metal alginate salts of the plant treatment compositions taught herein. Wherein the first amine compound is ammonia it may be formed in situ by a suitable reaction, e.g., the reaction of ammonium carbonate with water. The first amine compound should be present in sufficient amounts in order to ensure that the final desired ultimate concentration of the metal alginate salts, based on the parts per million of the metal, are formed when the plant treatment compositions are formed. Advantageously the first amine compound is present in amount of from 0.001% wt. to about 5% wt. in concentrated forms of the plant treatment compositions which may be later diluted in a larger quantity of a suitable liquid carrier medium, e.g., water, such as in a tank mix, which diluted composition is used as the plant treatment composition. Preferred amounts of the first amine compound are disclosed with reference to one or more of the examples.

Also as noted above, the plant treatment compositions also necessarily include a pH buffer composition comprising a second amine compound, e.g., preferably compounds which include nitrogen atom containing compounds which form complexes or salts with one or more acetates. Ammonium acetate is particularly preferred, although it is contemplated that other nitrogen atom containing compounds may be used particularly where they may be used as pH buffers to maintain an alkaline pH, and/or those which form complexes or salts with one or more acetates may be used as well. Advantageously the second amine compound is present in amount of from 0.001% wt. to about 5% wt. in concentrated forms of the plant treatment compositions which may be later diluted in a larger quantity of a suitable liquid carrier medium, e.g., water, such as in a tank mix, which diluted composition is used as the plant treatment composition. Preferred amounts of the pH buffer composition comprising, or consisting of the second amine compound are disclosed with reference to one or more of the examples

Notwithstanding the above it is to be understood that the plant treatment compositions taught herein may in certain embodiments omit the first amine compound and/or the pH buffer composition comprising the second amine compound if the plant treatment compositions are provided as two or more separate components, one of which components comprises the alginate or alginic acid and optional constituents, e.g. a carrier, and the metal, an inorganic and/or organic compound or species which releases a suitable metal ion and optional constituents, e.g., a carrier, such that the desired metal alginate salts are formed shortly prior to application onto a plant, plant surface or crop.

Although it is contemplated that while the plant treatment compositions of the invention may be provided in a powdered or pulvurent form, it is expected that the plant treatment compositions are more conveniently provided in a liquid, gel, foam or paste form which facilitates their dilution or dispersion in a larger volume of a suitable liquid carrier. The plant treatment compositions are advantageously provided in a liquid carrier system, e.g., in an aqueous or other fluid carrier which permits for the convenient mixing of a measured quantity of a concentrated form of the plant treatment compositions with a larger volume of water or other liquid carrier in which the concentrated form is diluted, such as in forming a tank mix, or the plant treatment compositions may be provided in a form such that no further dilution is required and such plant treatment compositions may be used directly in the treatment of plants, viz, as a ready-to-use type product.

While not wishing to be bound by the following hypothesis, it is believed that the metallic salt alginates have a degree of surface “tackiness” when a formulation containing the same is applied from an aqueous solution to plant surfaces, and that at least the metallic salt alginate adhere to the plant foliage, fruit or crop to which it has been applied. This tackiness increases the amount of metallic salt alginates which adhere to the plant matter surfaces and also retains the metallic salt alginates on the plant surfaces which is believed to enhance their durability and retention on plant surfaces, and thereby provide a longer lasting benefit. While the mechanism is not clearly understood, it has nonetheless surprisingly been observed that the metal alginate salts appear to provide a beneficial effect even in the absence of conventional pesticides, fungicides, or herbicides particularly as is demonstrated in one or more of the following examples. It is hypothesized that the metal contributes to the beneficial effect.

Thus according to certain embodiments, in one aspect, the present invention provides plant treatment compositions which include a metal alginate salt and/or metal salt of an alginic acid, preferably wherein the metal alginate salts are copper salts or silver salts, and especially preferably wherein the composition includes a sufficient amount of copper alginates which ultimately provides between 0.5 ppm and 50,000 ppm of metallic copper in the form of Cu(I) and/or Cu(II) ions as applied to a plant or plant part, and a liquid carrier, preferably a liquid carrier which is water or which is a largely aqueous liquid carrier, with the proviso that the plant treatment compositions include both as a first amine compound(s), one or more amine compounds selected from: ammonia, primary amines, secondary amines or tertiary amines, as well as salts thereof, and further wherein the compositions also include pH buffer composition comprising or in certain embodiments, consists of, a second amine compound.

According to yet further preferred embodiments, in a further aspect, the present invention provides plant treatment compositions which include a metal alginate salt and/or metal salt of an alginic acid, preferably wherein the metal alginate salts are copper salts or silver salts, and especially preferably wherein the composition includes a sufficient amount of copper alginates which ultimately provides between 0.5 ppm and 50,000 ppm of metallic copper in the form of Cu(I) and/or Cu(II) ions as applied to a plant or plant part, and a liquid carrier, preferably a liquid carrier which is water or which is a largely aqueous liquid carrier, with the proviso that the plant treatment compositions include one or more first amine compounds selected from: ammonia, primary amines, secondary amines or tertiary amines, as well as salts thereof, as well as pH buffer composition comprising, or in certain embodiments consists of, a second amine compound, with the further proviso that the plant treatment compositions also exclude biologically active materials which exhibit or provide pesticidal, disease control, including fungicidal, mildew control or herbicidal or plant growth regulating effects.

In yet another aspect of the invention there are provided plant treatment compositions of the invention which are provided at least two separate constituents, one of the constituents comprising the alginic acid or alginate and optional constituents, while a separate component comprises the metal, an inorganic and/or organic compound or species which releases a suitable metal ion and optional constituents, such that the desired metal alginate salts are formed shortly prior to application onto a plant, plant surface or crop. Such plant treatment compositions provided by the foregoing method may omit, and preferably do exclude, the one or more first amine compounds as well as salts thereof and/or exclude the pH buffer composition comprising a second amine compound, which would form a complex with the suitable metal ions intended to form the metal alginate salts. Preferably in such plant treatment compositions the metal alginate salts are copper salts or silver salts, and especially preferably wherein the composition includes a sufficient amount of copper alginates which ultimately provides between 0.5 ppm and 50,000 ppm of metallic copper in the form of Cu(I) and/or Cu(II) ions as applied to a plant or plant part.

In addition to the essential constituents disclosed above, the plant treatment compositions of the invention may include one or more further additional optional constituents which may be used to provide one or more further technical effects or benefits to the plant treatment compositions.

Optionally, but in certain cases preferably, the plant treatment compositions of the invention include adhesion promoters and/or plasticizers. Such materials enable a better and longer lasting adhesion of the plant treatment compositions of the invention to the surfaces being treated, e.g., plant surfaces, etc.

Once class of exemplary adhesion promoters include gelatinizing substances which include, but are not limited to, paraffin wax, beeswax, honey, corn syrup, cellulose carboxy-methylether, guar gum, carob gum, tracanth gum, pectin, gelatine, agar, cellulose carboxy-methylether sodium salt, cellulose, cellulose acetate, dextrines, cellulose-2-hydroxyethylether, cellulose-2-hydroxypropylether, cellulose-2-hydroxypro-pylmethylester, cellulosemethylether, cornstarch, sodium alginate, maltodextrin, xanthan gum, epsilon-caprolactampolymer, dia-tomeen soil, acrylic acid polymers, PEG-30 glyceryl-cocoat, PEG-200, hydrogenated glyceryl-palmitate, and any combinations thereof. In one example, an acrylic acid polymer is an acrylic acid polymer that is sold under the brand name Carbomar® (ex. Degussa.). A further class of exemplary adhesion promoters include Further suitable adhesive promoters include block copolymers EO/PO surfactants, as well as polymers such as polyvinylalcohols, polyvinylpyrrolidones, polyacrylates, polymethacrylates, polybutenes, polyisobutylenes, polystyrene, polyethyleneamines, polyethyleneamides, polyethyleneimines (Lupasol®, Polymin®), polyethers and copolymers derived from these polymers.

One or more plasticizers may also be present in the plant treatment compositions according to the invention, and many plasticizers may also function as adhesion promoters as well. Typically plasticizers are low molecular weight organic compounds generally with molecular weights between 50 and 1000. Examples include, but are not limited to: polyols (polyhydric alcohols), for example alcohols with many hydroxyl groups such as glycerol, glycerin, ethylene glycol, diethylene glycol, triethylene glycol, propylene glycol, dipropylene glycol, polyethylene glycol; polar low molecular weight organic compounds, such as urea, sugars, sugar alcohols, oxa diacids, diglycolic acids; and other linear carboxylic acids with at least one ether group, C₁-C₁₂ dialkyl phthalates. Further non-limiting examples of further useful plasticizers include ethanolacetamide; ethanolformamide; triethanolamines such as triethanolamine acetate; thiocyanates, such as sodium and ammonium thiocyanates.

When present, the adhesion promoters and/or plasticizers typically comprise between 0.0001% wt. to about 10% wt., when the plant treatment compositions are provided as a concentrated composition, and alternately the adhesion promoters typically comprise between 0.01% wt. to about 1% wt., when the plant treatment compositions are provided as a either a tank mixed composition or ready-to use composition. It is understood that the adhesion promoter may be supplied as a separate constituent and not form a constituent of a concentrated composition the plant treatment compositions, but may be added as a co-constituent to a larger volume of a carrier, e.g., water such as when forming a tank mix composition for use.

In certain particularly preferred compositions of the invention an adhesion promoter and/or plasticizer is necessarily present as an essential constituent.

The plant treatment compositions of invention may optionally include one or more constituents or materials especially other biologically active materials, e.g., materials which exhibit or provide pesticidal, disease control, including fungicidal, mildew control or herbicidal or plant growth regulating effects, as well as one or more non-biologically active materials.

By way of nonlimiting examples, examples of biologically active materials include materials which exhibit or provide pesticidal, disease control, including fungicidal, mildew control or herbicidal or plant growth regulating effects. All, or some of such biologically active materials may be excluded from the plant treatment compositions of the invention in accordance with specific preferred embodiments thereof.

Exemplary fungicides which may be used in the plant treatment compositions of the invention include one or more of: 2-phenylphenol; 8-hydroxyquinoline sulfate; AC 382042; Ampelomyces quisqualis; Azaconazole; Azoxystrobin; Bacillus subtilis; Benalaxyl; Benomyl; Biphenyl; Bitertanol; Blasticidin-S; Bordeaux mixture; Borax; Bromuconazole; Bupirimate; Calboxin; calcium polysulfide; Captafol; Captan; Carbendazim; Carpropanmid (KTU 3616); CGA 279202; Chinomethionat; Chlorothalonil; Chlozolinate; copper hydroxide; copper naphthenate; copper oxychloride; copper sulfate; cuprous oxide; Cymoxanil; Cyproconazole; Cyprodinil; Dazomet; Debacarb; Dichlofluanid; Dichlomezine; Dichlorophen; Diclocymet; Dicloran; Diethofencarb; Difenoconazole; Difenzoquat; Difenzoquat metilsulfate; Diflumetorim; Dimethirimol; Dimethomorph; Diniconazole; Diniconazole-M; Dinobuton; Dinocap; diphnenylamine; Dithianon; Dodemorph; Dodemorph acetate; Dodine; Dodine free base; Edifenphos; Epoxiconazole (BAS 480F); Ethasulfocarb; Ethirimol; Etridiazole; Famoxadone; Fenamidone; Fenarimol; Fenbuconazole; Fenfin; Fenfuram; Fenhexamid; Fenpiclonil; Fenpropidin; Fenpropimorph; Fentin acetate; Fentin hydroxide; Ferbam; Ferimzone; Fluazinam; Fludioxonil; Fluoroimide; Fluquinconazole; Flusilazole; Flusulfamide; Flutolanil; Flutriafol; Folpet; formaldehyde; Fosetyl; Fosetyl-aluminum; Fuberidazole; Furalaxyl; Fusarium oxysporum; Gliocladium virens; Guazatine; Guazatine acetates; GY-81; hexachlorobenzene; Hexaconazole; Hymexazol; ICIA0858; IKF-916; Imazalil; Imazalil sulfate; Imibenconazole; Iminoctadine; Iminoctadine triacetate; Iminoctadine tris[Albesilate]; Ipconazole; Iprobenfos; Iprodione; Iprovalicarb; Kasugamycin; Kasugamycin hydrochloride hydrate; Kresoxim-methyl; Mancopper; Mancozeb; Maneb; Mepanipyrim; Mepronil; mercuric chloride; mercuric oxide; mercurous chloride; Metalaxyl; Metalaxyl-M; Metam; Metam-sodium; Metconazole; Methasulfocarb; methyl isothiocyanate; Metiram; Metominostrobin (SSF-126); MON65500; Myclotbutanil; Nabam; naphthenic acid; Natamycin; nickel bis(dimethyldithiocarbamate); Nitrothal-isopropyl; Nuarimol; Octhilinone; Ofurace; oleic acid (fatty acids); Oxadixyl; Oxine-copper; Oxycarboxin; Penconazole; Pencycuron; Pentachlorophenol; pentachlorophenyl laurate; Perfurazoate; phenylmercury acetate; Phlebiopsis gigantea; Phthalide; Piperalin; polyoxin B; polyoxins; Polyoxorim; potassium hydroxyquinoline sulfate; Probenazole; Prochloraz; Procymidone; Propamocarb; Propamocarb Hydrochloride; Propiconazole; Propineb; Pyrazophos; Pyributicarb; Pyrifenox; Pyrimethanil; Pyroquilon; Quinoxyfen; Quintozene; RH-7281; sec-butylamine; sodium 2-phenylphenoxide; sodium pentachlorophenoxide; Spiroxamine (KWG 4168); Streptomyces griseoviridis; sulfur; tar oils; Tebuconazole; Tecnazene; Tetraconazole; Thiabendazole; Thifluzamide; Thiophanate-methyl; Thiram; Tolclofos-methyl; Tolylfluanid; Triadimefon; Triadimenol; Triazoxide; Trichoderma harzianum; Tricyclazole; Tridemorph; Triflumizole; Triforine; Triticonzole; Validamycin; vinclozolin; zinc naphthenate; Zineb; Ziram; the compounds having the chemical name methyl (E,E)-2-(2-(1-(1-(2-pyridyl)propyloxyimino)-1-cyclopropylmethyloxymethyl)phenyl)-3-ethoxypropenoate and 3-(3,5-dichlorophenyl)-4-chloropyrazole.

When present the one or more fungicides, may be included in any effective amount, and advantageously are present in amounts of from 1 ppm to 50,000 ppm, preferably 10 ppm to 10,000 ppm based on total weight of the plant treatment composition of which it forms a part, as applied to the plant. The concentration of such one or more fungicides will of course be expected to be higher when present in a concentrated form of the composition of the invention, e.g., a concentrate form which is supplied to the ultimate user of the produce, e.g. grower, wherein such a concentrate is intended to be diluted in a liquid and/or solid carrier, e.g., largely aqueous tank mixes wherein the dilution ratio of the concentrate form to the liquid and/or solid carrier is intended to provide a plant treatment composition to be used directly upon plants or crops.

Exemplary pesticides include insecticides, acaricides and nematocides, which be used singly or in mixtures in the plant treatment compositions of the invention. By way of non-limiting example such include one or more of: Abamectin; Acephate; Acetamiprid; oleic acid; Acrinathrin; Aldicarb; Alanycarb; Allethrin [(1R) isomers]; .alpha.-Cypermethrin; Amitraz; Avermectin B1 and its derivatives, Azadirachtin; Azamethiphos; Azinphos-ethyl; Azinphosmethyl; Bacillus thurigiensi; Bendiocarb; Benfuracarb; Bensultap; .beta.-cyfluthrin; .beta.-cypermethrin; Bifenazate; Bifenthrin; Bioallathrin; Bioallethrin (S-cyclopentenyl isomer); Bioresmethrin; Borax; Buprofezin; Butocarboxim; Butoxycarboxim; piperonyl butoxide; Cadusafos; Carbaryl; Carbofuran; Carbosulfan; Cartap; Cartap hydrochloride; Chordane; Chlorethoxyfos; Chlorfenapyr; Chlorfenvirnphos; Chlorfluazuron; Chlormephos; Chloropicrin; Chlorpyrifos; Chlorpyrifos-methyl; mercurous chloride; Coumaphos; Cryolite; Cryomazine; Cyanophos; calcium cyanide; sodium cyanide; Cycloprothrin; Cyfluthrin; Cyhalothrin; cypermethrin; cyphenothrin [(1R) transisomers]; Dazomet; DDT; Deltamethrin; Demeton-5-methyl; Diafenthiuron; Diazinon; ethylene dibromide; ethylene dichloride; Dichlorvos; Dicofol; Dicrotophos; Diflubenzuron; Dimethoate; Dimethylvinphos; Diofenolan; Disulfoton; DNOC; DPX-JW062 and DP; Empenthrin [(EZ)-(1R) isomers]; Endosulfan; ENT 8184; EPN; Esfenvalerate; Ethiofencarb; Ethion; Ethiprole having the chemical name 5-amino-3-cyano-1-(2,6-dichloro-4-trifluoromethylphenyl)-4-ethylsulfinylpyrazole; Ethoprophos; Etofenprox; Etoxazole; Etrimfos; Famphur; Fenamiphos; Fenitrothion; Fenobucarb; Fenoxycarb; Fenpropathrin; Fenthion; Fenvalerate; Fipronil and the compounds of the arylpyrazole family; Flucycloxuron; Flucythrinate; Flufenoxuron; Flufenprox; Flumethrin; Fluofenprox; sodium fluoride; sulfuryl fluoride; Fonofos; Formetanate; Fonnetanate hydrochloride; Formothion; Furathiocarb; Gamma-HCH; GY-81; Halofenozide; Heptachlor; Heptenophos; Hexaflumuron; sodium hexafluorosilicate; tar oils; petroleum oils; Hydramethylnon; hydrogen cyanide; Hydroprene; Imidacloprid; Imiprothrin; Indoxacarb; Isazofos; Isofenphos; Isoprocarb; Methyl isothiocyanal; Isoxathion; lambda-Cyhalothrin; pentachlorophenyl laurate; Lufenuron; Malathion; MB-599; Mecarbam; Methacrifos; Methamidophos; Methidathion; Methiocarb; Methomyl; Methoprene; Methoxychlor; Metolcarb; Mevinphos; Milbemectin and its derivatives; Monocrotophos; Naled; nicotine; Nitenpyram; Nithiazine; Novaluron; Omethoate; Oxamyl; Oxydemeton-methyl; Paecilomyces fumosoroseus; Parathion; Parathion-methyl; pentachlorophenol; sodium pentachlorophenoxide; Permethrin; Penothrin [(1R)-trans-isomers]; Phenthoate; Phorate; Phosalone; Phosmet; Phosphamidon; phosphine; aluminum phosphide; magnesium phosphide; zinc phosphide; Phoxim; Pirimicarb; Pirimiphos-ethyl; Pirimiphos-methyl; calcium polysulfide; Prallethrin; Profenfos; Propaphos; Propetamphos; Propoxur; Prothiofos; Pyraclofos; pyrethrins (chrysanthemates, pyrethrates, pyrethrum; Pyretrozine; Pyridaben; Pyridaphenthion; Pyrimidifen; Pyriproxyfen; Quinalphos; Resmethrin; RH-2485; Rotenone; RU 15525; Silafluofen; Sulcofuron-sodium; Sulfotep; sulfuramide; Sulprofos; Ta-fluvalinate; Tebufenozide; Tebupirimfos; Teflubenzuron; Tefluthrin; Temephos; Terbufos; Tetrachlorvinphos; Tetramethrin; Tetramethrin [(1R) isomers]; .theta.-cypermethrin; Thiametoxam; Thiocyclam; Thiocyclam hydrogen oxalate; Thiodicarb; Thiofanox; Thiometon; Tralomethrin; Transfluthrin; Triazamate; Triazophos; Trichlorfon; Triflumuron; Trimethacarb; Vamidothion; XDE-105; XMC; Xylylcarb; Zeta-cypermethrin; ZXI 8901; the compound whose chemical name is 3-acetyl-5-amino-1-[2,6-dichloro-4-(trifluoromethyl)phenyl]-2-methylsulfinylpyrazole.

When present the one or more pesticides, may be included in any effective amount, and advantageously are present in amounts of from 5 ppm to 50,000 ppm, preferably 10 ppm to 10,000 ppm based on total weight of the plant treatment composition of which it forms a part, particularly in final end-use concentrations of the plant treatment compositions as applied to the plant.

Exemplary herbicides which may be used in the plant treatment compositions of the invention, may include one or more of: 2,3,6-TBA; 2,4-D; 2,4-D-2-ethylhexyl; 2,4-DB; 2,4-DB-butyl; 2,4-DB-dimethylammonium; 2,4-DB-isooctyl; 2,4-DB-potassium; 2,4-DB-sodium; 2,4-D-butotyl (2,4-D-Butotyl (2,4-D Butoxyethyl Ester)); 2,4-D-butyl; 2,4-D-dimethylammonium; 2,4-D-Diolamine; 2,4-D-isoctyl; 2,4-D-isopropyl; 2,4-D-sodium; 2,4-D-trolamine; Acetochlor; Acifluorfen; Acifluorfen-sodium; Aclonifen; Acrolein; AKH-7088; Alachlor; Alloxydim; Alloxydim-sodium; Ametryn; Amidosulfuron; Amitrole; ammonium sulfamate; Anilofos; Asulam; Asulam-sodium; Atrazine; Azafenidin; Azimsulfuron; Benazolin; Benazolin-ethyl; Benfluralin; Benfuresate; Benoxacor; Bensulfuron; Bensulfuron-methyl; Bensulide; Bentazone; Bentazone-sodium; Benofenap; Bifenox; Bilanofos; Bilanafos-sodium; Bispyribac-sodium; Borax; Bromacil; Bromobutide; Bromofenoxim; Bromoxynil; Bromoxynil-heptanoate; Bromoxynil-octanoate; Bromoxynil-potassium, Butachlor; Butamifos; Butralin; Butroxydim; butylate; Cafenstrole; Carbetamide; Carfentrazone-ethyl; Chlomethoxyfen; Chloramben; Chlorbromuron; Chloridazon; Chlorimuron; Chlorimuron-ethyl; Chloroacetic Acid; Chlorotoluron; Chlorpropham; Chlorsulfuron; Chlorthal; Chlorthal-dimethyl; Chlorthiamid; Cinmethylin; Cinosulfuron; Clethodim; Clodinafop; Clodinafop-Propargyl; Clomazone; Clomeprop; Clopyralid; Clopyralid-Olamine; Cloquintocet; Cloquintocet-Mexyl; Chloransulam-methyl; CPA; CPA-dimethylammonium; CPA-isoctyl; CPA-thioethyl; Cyanamide; Cyanazine; Cycloate; Cyclosulfamuron; Cycloxydim; Cyhalofop-butyl; Daimuron; Dalapon; Dalapon-sodium; Dazomet; Desmeduipham; Desmetryn; Dicamba; Dicamba-dimethylammonium; Dicamba-potassium; Dicamba-sodium; Dicamba-trolamine; Dichiobenil; Dichlormid; Dichlorprop; Dichlorprop-butotyl (Dichlorprop-butotyl (Dichlorpropbutoxyethyl ester)); Dichlorprop-dimethylammonium; Dichlorprop-isoctyl; Dichlorprop-P; Dichlorprop-potassium; Diclofop; Diclofop-methyl; Difenzoquat; Difenzoquat metilsulfate; Diflufenican; Diflufenzopyr (BAS 654 00 H); Dimefuron; Dimepiperate; Dimethachlor; Dimethametryn; Dimethenamid; Dimethipin; dimethylarsinic acid; Dinitramine; Dinoterb; Dinoterb acetate; Dinoterb-ammonium; Dinoterb-diolamine; Diphenamid; Diquat; Diquat dibromide; Dithiopyr; Diuron; DNOC; DSMA; Endothal; EPTC; Esprocarb; Ethalfluralin; Ethametsulfuron-methyl; Ethofumesate; Ethoxysulfuron; Etobenzanid; Fenchlorazole-ethyl; Fenclorim; Fenoxaprop-P; Fenoxaprop-P-ethyl; Fenuron; Fenuron-TCA; Ferrous Sulfate; Flamprop-M; Flamprop-M-Isopropyl; Flamprop-M-methyl; Flazasulfuron; Fluazifop; Fluazifop-butyl; Fluazifop-P; Fluazifop-P-butyl; Fluazolate; Fluchloralin; Flufenacet (BAS FOE 5043); Flumetsulam; Flumiclorac; Flumiclorac-Pentyl; Flumioxazin; Fluometuron; Fluoroglycofen; Fluoroglycofen-ethyl; Flupaxam; Flupoxam; Flupropanate; Flupropanate-sodium; Flupyrsulfuron-methyl-sodium; Flurazole; Flurenol; Flurenol-butyl; Fluridone; Fluorochloridone; Fluoroxypyr; Fluoroxypyr-2-Butoxy-1-methylethyl; Fluoroxypyr-methyl; Flurtamone; Fluthioacet-methyl; Fluxofenim; Fomesafen; Fomesafen-sodium; Fosamine; Fosamine-ammonium; Furilazole; Glyphosate; Glufosinate; Glufosinate-ammonium; Glyphosate-ammonium; Glyphosate-isopropylammonium; Glyphosate-sodium; Glyphosate-trimesium; Halosulfuron; Halosulfuron-methyl; Haloxyfop; Haloxyfop-P-methyl; Haloxyfop-etotyl; Haloxyfop-methyl; Hexazinone; Hilanafos; Imazacluin; Imazamethabenz; Imazamox; Imazapyr; Imazapyr-isopropylammonium; Imazaquin; Imazaquin-ammonium; Imazemethabenz-methyl; Imazethapyr; Imazethapyr-ammonium; Imazosulfuron; Imizapic (AC 263,222); Indanofan; Ioxynil; Ioxynil octanoate; Ioxynil-sodium; Isoproturon; Isouron; Isoxaben; Isoxaflutole; Lactofen; Laxynel octanoate; Laxynil-sodium; Lenacil; Linuron; MCPA; MCPA-butotyl; MCPA-dimethylammonium; MCPA-isoctyl; MCPA-potassium; MCPA-sodium; MCPA-thioethyl; MCPB; MCPB-ethyl; MCPB-sodium; Mecoprop; Mecoprop-P; Mefenacet; Mefenpyr-diethyl; Mefluidide; Mesulfuron-methyl; Metam; Metamitron; Metam-sodium; Metezachlor; Methabenzthiazuron; methyl isothiocyanate; methylarsonic acid; Methyldymron; Metobenzuron; Metobromuron; Metolachlor; Metosulam; Metoxuron; Metribuzin; Metsulfuron; Molinate; Monolinuron; MPB-sodium; MSMA; Napropamide; Naptalam; Naptalam-sodium; Neburon; Nicosulfuron; nonanoic acid; Norflurazon; oleic acid (fatty acids); Orbencarb; Oryzalin; Oxabetrinil; Oxadiargyl; Oxasulfuron; Oxodiazon; Oxyfluorfen; Paraquat; Paraquat Dichloride; Pebulate; Pendimethalin; Pentachlorophenol; Pentachlorophenyl Laurate; Pentanochior; Pentoxazone; petroleum oils; Phenmedipham; Picloram; Picloram-potassium; Piperophos; Pretilachlor; Primisulfuron; Primisulfuron-methyl; Prodiamine; Prometon; Prometryn; Propachlor; Propanil; Propaquizafop; Propazine; Propham; Propisochlor; Propyzamide; Prosulfocarb; Prosulfuron; Pyraflufen-ethyl; Pyrazasulfuron; Pyrazolynate; Pyrazosulfuron-ethyl; Pyrazoxyfen; Pyribenzoxim; Pyributicarb; Pyridate; Pyriminobac-methyl; Pyrithiobac-sodium; Quinclorac; Quinmerac; Quinofolamine; Quizalofop; Quizalofop-ethyl; Quizalofop-P; Quizalofop-P-ethyl; Quizalofop-P-Tefuryl; Rimsulfuron; Sethoxydim; Siduron; Simazine; Simetryn; sodium chlorate; sodium chloroacetate; sodium pentachlorophenoxide; sodium-Dimethylarsinate; Sulcotrione; Sulfentrazone; Sulfometuron; Sulfometuron-methyl; Sulfosulfuron; Sulfuric acid; tars; TCA-sodium; Tebutam; Tebuthiuron; Tepraluxydim (BAS 620H); Terbacil; Terbumeton; Terbuthylazine; Terbutryn; Thenylchlor; Thiazopyr; Thifensulfuron; Thifensulfuron-methyl; Thiobencarb; Tiocarbazil; Tralkoxydim; triallate; Triasulfuron; Triaziflam; Tribenuron; Tribenuron-methyl; Tribenuron-methyl; trichloroacetic acid; Triclopyr; Triclopyr-butotyl; Triclopyr-triethylammonium; Trietazine; Trifluralin; Triflusulfuron; Triflusulfuron-methyl; Vemolate: YRC 2388.

When present the one or more herbicides, may be included in any effective amount, and advantageously are present in amounts of from 5 ppm to 50,000 ppm, preferably 10 ppm to 10,000 ppm based on total weight of the plant treatment composition of which it forms a part, particularly in final end-use concentrations of the plant treatment compositions as applied to the plant.

The composition of the invention may further contain one or more non-biologically active materials which include, but are not limited to one or more of: surfactants, solvents, e.g., non-aqueous solvents, safeners, binders, stabilizers, dyes, fragrances, further different pH buffers, pH adjusting agents, chelating agents, and lubricants according to the requirements of a particular plant treatment composition.

Non-limiting examples of surfactants useful in the plant treatment compositions of the invention include one or more of anionic, nonionic, cationic, amphoteric and zwitterionic surfactants, which can be used singly or in mixtures. Exemplary nonionic surfactants include polyoxyethylene alkyl ethers, polyoxyethylene alkyl allyl ethers, polyoxyethylene lanolin alcohols, polyoxyethylene alkyl phenol formalin condensates, polyoxyethylene sorbitan fatty acid esters, polyoxyethylene glycerol mono-fatty acid esters, polyoxypropylene glycol mono-fatty acid esters, polyoxyethylene sorbitol fatty acid esters, polyoxyethylene-castor oil derivatives, polyoxyethylene fatty acid esters, fatty acid glycerol esters, sorbitan fatty acid esters, sucrose fatty acid esters, polyoxyethylene polyoxypropylene block polymers, polyoxyethylene fatty acid amides, alkylol amides, and polyoxyethylene alkyl amines; aminonic surfactants include sodium salts of fatty acids such as sodium palmitate, ether sodium carboxylates such as polyoxyethylene lauryl ether sodium carboxylate, amino acid condensates of fatty acids such as lauroyl sodium sarcosine and N-lauroyl sodium glutamate, alkylarylsulfonates such as sodium dodecylbenzenesulfonate and diisopropylnaphthalenesulfonates, fatty acid ester sulfonates such as lauric acid ester sulfonates, dialkyl sulfosuccinates such as dioctyl sulfosuccinate, fatty acid amidosulfonates such as oleic acid amidosulfonate, formalin condensates of alkylarylsulfonates, alcohol sulfates such as pentadecane-2-sulfate, polyoxyethylene alkyl ether sulfates such as polyoxyethylene dodecyl ether sodium sulfate, polyoxyethylene alkyl phosphates such as dipolyoxyethylene dodecyl ether phosphates, styrene-maleic acid copolymers, and alkyl vinyl ether-maleic acid copolymers; and amphoteric surfactants such as N-laurylalanine, N,N,N-trimethylaminopropionic acid, N,N,N-trihydroxye thylaminopropionic acid, N-hexyl N,N-dimethylaminoacetic acid, 1-(2-carboxyethyl)-pyridiniumbetaine, and lecithin; exemplary cationic surfactants include alkylamine hydrochlorides such as dodecylamine hydrochloride, benzethonium chloride, alkyltrimethylammoniums such as dodecyltrimethylammonium, alkyldimethylbenzylammoniums, alkylpyridiniums, alkylisoquinoliniums, dialkylmorpholiniums, and polyalkylvinylpyridiniums.

Non-limiting examples of solvents useful in the plant treatment compositions of the invention include one or more of saturated aliphatic hydrocarbons such as: decane, tridecane, tetradecane, hexadecane, and octadecane; unsaturated aliphatic hydrocarbons such as 1-undecene and 1-henicosene; halogenated hydrocarbons; ketones such as acetone and methyl ethyl ketone; alcohols such as methanol, ethanol, butanol, and octanol; esters such as ethyl acetate, dimethyl phthalate, methyl laurate, ethyl palmitate, octyl acetate, dioctyl succinate, and didecyl adipate; aromatic hydrocarbons such as xylene, ethylbenzene, octadecylbenzene, dodecylnaphthalene, tridecylnaphthalene; glycols, glycol esters, and glycol ethers such as ethylene glycol, diethylene glycol, propylene glycol monomethyl ether, and ethyl cellosolve; glycerol derivatives such as glycerol and glycerol fatty acid ester; fatty acids such as oleic acid, capric acid, and enanthic acid; polyglycols such as tetraethylene glycol, polyethylene glycol, and polypropylene glycol; amides such as N,N-dimethylformamide and diethylformamide: animal and vegetable oils such as olive oil, soybean oil, colza oil, castor oil, linseed oil, cottonseed oil, palm oil, avocado oil, and shark oil; as well as mineral oils. Water and blends of water with one or more of the foregoing organic solvents are also expressly contemplated as being useful solvent constituents.

Non-limiting examples of stabilizers which may be used in the invention are one or more of antioxidants, light stabilizers, ultraviolet stabilizers, radical scavengers, and peroxide decomposers. Examples of the antioxidant are antioxidants of phenol type, amine type, phosphorus type, and sulfur type antioxidants. Examples of the ultraviolet stabilizer are that of benzotriazole type, cyanoacrylate type, salicylic acid type, and hindered amine type. Isopropyl acid phosphate, liquid paraffin, and epoxidized vegetable oils like epoxidized soybean oil, linseed oil, and colza oil may also be used as the stabilizer.

Non-limiting examples of chelating agents which may be any of those known to those skilled in the art such as the ones selected from the group comprising phosphonate chelating agents, amino carboxylate chelating agents, other carboxylate chelating agents, polyfunctionally-substituted aromatic chelating agents, ethylenediamine N,N′-disuccinic acids, or mixtures thereof. Further suitable phosphonate chelating agents to be used herein may include alkali metal ethane 1-hydroxy diphosphonates (HEDP) also known as ethydronic acid, alkylene poly (alkylene phosphonate), as well as amino phosphonate compounds, including amino aminotri(methylene phosphonic acid) (ATMP), nitrilo trimethylene phosphonates (NTP), ethylene diamine tetra methylene phosphonates, and diethylene triamine penta methylene phosphonates (DTPMP). The phosphonate compounds may be present either in their acid form or as salts of different cations on some or all of their acid functionalities. Preferred phosphonate chelating agents to be used herein are diethylene triamine penta methylene phosphonate (DTPMP) and ethane 1-hydroxy diphosphonate (HEDP or ethydronic acid). Such phosphonate chelating agents are commercially under the trade name DEQUEST® (ex. Degussa). Polyfunctionally-substituted aromatic chelating agents may also be useful in the compositions herein. See U.S. Pat. No. 3,812,044, issued May 21, 1974, to Connor et al. Preferred compounds of this type in acid form are dihydroxydisulfobenzenes such as 1,2-dihydroxy-3,5-disulfobenzene. An exemplary and preferred biodegradable chelating agent for use herein is ethylene diamine N,N′-disuccinic acid, or alkali metal, or alkaline earth, ammonium or substitutes ammonium salts thereof or mixtures thereof. Ethylenediamine N,N′-disuccinic acids, especially the (S,S) isomer have been extensively described in U.S. Pat. No. 4,704,233, Nov. 3, 1987, to Hartman and Perkins.

Further suitable chelating agents include amino carboxylates including include ethylene diamine tetra acetates, diethylene triamine pentaacetates, diethylene triamine pentaacetate (DTPA), N-hydroxyethylethylenediamine triacetates, nitrilotri-acetates, ethylenediamine tetrapropionates, triethylenetetraaminehexa-acetates, ethanol-diglycines, propylene diamine tetracetic acid (PDTA) and methyl glycine di-acetic acid (MGDA), both in their acid form, or in their alkali metal, ammonium, and substituted ammonium salt forms. Particularly suitable amino carboxylates to be used herein are diethylene triamine penta acetic acid, propylene diamine tetracetic acid (PDTA) which is, for instance, commercially available from BASF under the trade name Trilon FS® and methyl glycine di-acetic acid (MGDA). Yet further useful chelating agents include carboxylate chelating such as salicylic acid, aspartic acid, glutamic acid, glycine, malonic acid or mixtures thereof. Such one or more chelating agents may be included in acceptable amounts.

In addition to the required pH buffer composition comprising a second amine compound which is most preferably an amine containing acetate compound, the plant treatment compositions may include one or more further pH adjusting agents and/or pH buffers. In certain preferred embodiments such a preferred pH adjusting agent and/or pH treatment composition is a further essential constituent in the inventive compositions. Essentially an material which may be used to adjust the pH of the plant treatment compositions are considered suitable, non-limiting examples of which include one or more of inorganic acids, organic acids, bases, alkaline materials, hydroxides, hydroxide generators, as well as mixtures thereof.

Also suitable as pH-adjusting agents are monoethanolamine compounds, such as diethanolamine and triethanolamine, and beta-aminoalkanol compounds, particularly beta-aminoalkanols having a primary hydroxyl group, and a mixture thereof. Further nonlimiting examples of pH-adjusting agents include alkali metal salts of various inorganic acids, such as alkali metal phosphates, polyphosphates, pyrophosphates, triphosphates, tetraphosphates, silicates, metasilicates, polysilicates, borates, carbonates, bicarbonates, hydroxides, and mixtures of same. It may also be suitable to use buffers such materials as aluminosilicates (zeolites), borates, aluminates and certain organic materials such as gluconates, succinates, maleates, citrates, and their alkali metal salts. A preferred pH-adjusting agent is an alkali metal hydroxide. In certain preferred embodiments, citrates and/or alkali metal salts of citrates, e.g., sodium citrate, are expressly excluded from compositions of the invention. Such buffers keep the pH ranges of the compositions of the present invention within acceptable limits.

Each of the foregoing non-biologically active materials which may be individually included in effective amounts. The total amounts of the one or more non-biologically active materials may be as little as 0.001% wt., to as much as 99.999% wt., based on the total weight of the plant treatment composition of which said non-biologically active materials form a part, particularly in final end-use concentrations of the plant treatment compositions as applied to the plant.

Preferred biologically and non-biologically active materials which are preferred are those which are based on metal salts, which metals which may be complexed or bound to the alginates, as it is believed that such would form complexes which are potentially better retained.

The plant treatment compositions can be advantageously applied against a broad range of diseases in different crops. They may be applied as leaf, stem, root, into-water, seed dressing, nursery box or soil treatment compositions. Thus the plant treatment compositions of the invention can be applied to the seed, soil, pre-emergence, as well as post-emergence such as directly onto immature or mature plants. The plant treatment compositions of the invention can be applied according to conventional application techniques known to the art, including electrodynamic spraying techniques. It is hypothesized that at least the metal alginate salts are deposited and are retained on the plant matter surfaces after the carrier, viz., aqueous medium or aqueous organic solvent medium has evaporated.

The plant treatment compositions are believed to have broad applicability to pathogentic fungi and bacteria and other diseases in said plants and particularly food crops.

The plant treatment compositions are expected to have particular activity against pathogentic fungi, bacteria or other diseases in plants which are characterized to be resistant to copper or other metals, especially copper.

Citrus crop diseases which may be treated by the plant treatment compositions of the invention include: algal spot, melanose, scab, greasy spot, pink pitting, alternaria brown spot, phytophthora brown rot, sptoria spot, phytophthora foot rot, and citrus canker.

Field crop diseases which may be treated by the plant treatment compositions of the invention include: for alfalfa, cercospora leaf spot, leptosphaerulina leaf spot; for corn, bacteria stalk rot; for peanut, cercospora leaf spot; for potato and other tubers, early blight, late blight; for sugar beet, cercospora leaf spot, and for wheat, barley and oats, helminthosporium spot blotch, septoria leaf blotch.

Diseases of small fruits which are treatable by the plant treatment compositions of the invention include: for blackberry (including Aurora, Boysen, Cascade, Chehalem, Logan, Marion, Santiam, and Thornless Evergreen varietals), anthracnose, cane spot, leaf spot, pseudomonas blight, purple blotch, yellow rust; for blueberry, bacterial canker, fruit rot, phomopsis twig blight; for cranberry, fruit rot, rose bloom, bacterial stem canker, leaf blight, red leaf spot, stem blight, tip blight (monilinia); for currants and gooseberry, anthracnose, leaf Spot; for raspberry, anthracnose, cane spot, leaf spot, pseudomonas, blight, purple blotch, yellow rust; for strawberry, angular leaf spot (xanthomonas), leaf blight, leaf scorch, leaf spot.

Diseases of tree crops which may be treated by the plant treatment compositions of the invention include: in almond, apricot, cherry, plum, and prune trees and crops, bacterial blast (Pseudomonas), bacterial canker, coryneum blight (shot hole), blossom brown rot, black knot, cherry leaf spot; in apple trees and crops; anthracnose, blossom blast, european canker (nectria), shoot blast (Pseudomonas), apple scab, fire blight, collar root, crown rot; in avocado trees and crops, anthracnose, blotch, scab; in banana trees and crops, sigatoka (black and yellow types), black pitting; in cacao trees and crops, black pod, in coffee plants and crops, coffee berry disease (Collectotrichum coffeanum), bacterial blight (Pseudomonas syringae), leaf rust (Hemileia vastatrix), iron spot (Cercospora coffeicola), pink disease (Corticium salmonicolor); in filbert trees and crops, bacterial blight, eastern filbert blight, in mango trees and crops, anthracnose, in olive trees and crops, olive knot, peacock spot; in peach and nectarine trees and crops, bacterial blast (Pseudomonas), bacterial canker, bacterial spot (Xanthomonas), coryneum blight (shot dole), leaf curl, bacterial spot; in pear trees and crops, fire blight and blossom blast (Pseudomonas); in pecan trees and crops, kernel rot, shuck rot, (Phytophthora cactorum), zonate leaf spot (Cristulariella pyramidalis), ball moss, Spanish moss; in pistachio trees and crops, botryosphaeria panicle and shoot blight, botrytis blight, late blight (Alternaria alternate), septoria leaf blight; in quince trees and crops, fire blight, and in walnut trees and crops, walnut blight.

Diseases of small fruits which may be treated by the plant treatment compositions of the invention include: in green beans, brown spot, common blight, halo blight, in beets including table beets and beet greens, cercospora leaf spot; in carrots, alternaria leaf spot, cercospora leaf spot; in celery, celeriac, bacterial blight, cercospora early blight, septoria late blight; in crucifers such as broccoli, brussels sprout, cabbage, cauliflower, collard greens, mustard greens, and turnip greens, black leaf spot (Alternaria), black rot (Xanthomonas), downy mildew; in cucurbits such as cantaloupe, cucumber, honeydew, muskmelon, pumpkin, squash, watermelon, alternaria leaf spot, angular leaf spot, anthracnose, downy mildew, gummy stem blight, powdery mildew, watermelon bacterial fruit blotch; in eggplant, alternaria blight, anthracnose, phomopsis; in okra, anthracnose, bacterial leaf spot, leaf spots, pod spot, powdery mildew; in onions and garlic, bacterial blight, downy mildew, purple blotch; in peas, powdery mildew; in peppers, anthracnose, bacterial spot, cercospora leaf spot; in spinach, anthracnose, blue mold, cercospora leaf spot, white rust, in tomato, anthracnose, bacterial speck, bacterial spot, early blight, gray leaf mold, late blight, septoria leaf spot, and in watercress, cercospora, leaf spot.

Diseases of vines and fruits which may be treated by the plant treatment compositions of the invention include: in grapes, black rot, downy mildew, phomopsis, powdery mildew; in hops, downy mildew; in kiwi, Erwinia herbicola, Pseudomonas fluorescens, Pseudomonas syringae

The following further crops and diseases which may be treated by the plant treatment compositions of the invention include: in atemoya, anthracnose; in carambola, anthracnose; in chives, downy mildew; in dill, phoma leaf spot, rhizoctonia foliage blight; in ginseng, alternaria leaf blight, stem blight; in guava, anthracnose, red algae; in macadamia, anthracnose, phytophthora blight (P. capsici), raceme blight (Botrytis cinerea); in papaya, anthracnose; in parsley, bacterial blight (Pseudomonas sp.); in passion fruit, anthracnose; in sugar apple (Annona), Anthracnose, and in sycamore, Anthracnose.

Specific diseases of greenhouse and shadehouse crops which may be treated by the plant treatment compositions of the invention include: in non-bearing citrus plants, brown rot, citrus canker, greasy spot, melanose, pink pitting, scab; in cucumbers, angular leaf spot, downy mildew; in eggplant, alternaria blight, anthracnose; in tomato, anthracnose, bacterial speck, bacterial spot, early blight, gray leaf mold, late blight, septoria leaf spot.

Specific diseases of confiers which may be treated by the plant treatment compositions of the invention include: in Douglas fir, Rhabdocline Needlecast, in firs, needlecasts, in juniper, Antracnose, Phomopsis Twig Dieback, in Leyland cypress, Cercospora Needle Blight, in pine, needlecasts and in spruce, needlecasts.

The plant treatment compositions may also be useful to treat plants for controlling the incidence of one or more of: downy mildew, powdery mildew, plant rusts, blackspot, leaf spot, fruit spot, anthracnose, rhizoctonia blight, botrytis blight, fruit rot, late blight. Such may be applied to ornamental plants, e.g., African violet, Boston fern, cacti, Bromelaid, English ivy, philodendron, sedum, palms, yucca, roses and ornamental shrubs, as well as fruits and vegetables, e.g., beans, beets, spinach, chard, celery, corn, cabbage, cucumbers, zucchinia and other curbits, hops, lettuce, chard, onions, garlic, parsley, gooseberries, currants, strawberry, tomato, potato, eggplant as well as peppers.

The plant treatment compositions may be provided in a variety of product forms. In one such form a concentrated composition containing the metal alginate salts are provided in a form wherein the concentrated composition is intended to be blended or dispersed in a further fluid carrier such as water or other largely aqueous liquid, either without further biologically active materials or conjointly with one or more further biologically active materials, e.g., materials which exhibit or provide pesticidal, disease control, including fungicidal, mildew control or herbicidal or plant growth regulating effects, as well as any other further desired biologically inactive constituents which are recognized as being a useful in the art. In a further product form, the plant treatment compositions of the invention are provided as a ready to use product wherein the metal alginate salts are provided in the said composition at a concentration which requires no further dilution but can be directly applied to plants, or crops, viz., as a ready to use composition. In a still further product form, the metal alginate salts are provided in conjunction with one or more further biologically active materials, e.g., materials which exhibit or provide pesticidal, disease control, including fungicidal, mildew control or herbicidal or plant growth regulating effects, as well as any other further desired biologically inactive constituents, in the form of a premix, or in the form of a concentrate which is intended to be added to further the carrier medium, such as an aqueous liquid which may, or may not include further constituents already present therein.

The plant treatment composition may also be provided in a powdered or solid form, e.g., a comminuted solid which can be dispersed into a fluid carrier or medium, in a concentrated form, which may be a solid, liquid, or a gel which is intended to be further dissolved or dispersed in a carrier medium, such as a liquid which may be pressurized or non-pressurized, e.g., water. Such a plant treatment composition is advantageously and conveniently provided as a dispersible or dilutable concentrate composition which is then used in a “tank mix” which may optionally include further compositions or compounds, including but not limited to biologically active materials and non-biologically active materials.

The plant treatment compositions of the invention may also be provided in any suitable or conventional packaging means. For example, conventional containers such as bottles, or sachets containing a solid, liquid or fluid composition enclosed within a water-soluble film may be conveniently provided particularly when the former are provided in premeasured unit dosage forms. The latter are particularly useful in avoiding the need for measuring or packaging and provides a convenient means whereby specific doses that the plant treatment compositions can be provided.

The following examples further illustrate the present invention. It should be understood, however, that the invention is not limited solely to the particular examples given below.

### EXAMPLES

Plant treatment compositions according to the invention (which are identified by the letter “E” preceding a digit) as well as compositions provided as comparative examples (which are identified by the letter “C” preceding a digit) were produced, as indicated. In each of these compositions the amount of the indicated constituent is represented as parts by weight based on the total weight of the composition of which it formed a part. Additionally the amount of metallic copper, viz, Cu(II) ions was calculated and indicated as parts per million for each of the following formulae.

TABLE 1

| | E1 | C1 |
|---|---|---|
| | (% wt.) | (wt %) |
| copper sulfate | — | 12.90 |
| pentahydrate | | |
| copper hydroxide | 5 | — |
| Manugel ® LBA | 3 | 3.22 |
| ammonia solution | 16 | 15.48 |
| sodium citrate | — | 12.90 |
| ammonium sulfate | — | 12.90 |
| ammonium acetate | 12 | — |
| DI water | 64 | 42.58 |
| pH | 10.2 | 9.2 |
| Cu(II), ppm | 33000 | 32840 |

The identity of the specific constituents indicated on Table 1 (as well as in the examples described later) are described with more specificity on the following Table 2; in each of the example formulations the individual constituents were used “as supplied” and were 100% wt. active, unless otherwise indicated on Table 2.

TABLE 2

| | |
|---|---|
| copper sulfate | anhydrous copper sulfate pentahydrate, (98-100% |
| pentahydrate | active) |
| copper hydroxide | anhydrous copper hydroxide (93.5 w/w, |
| | equivalent to 60.9% w/w copper content) |
| Manugel ® LBA | low molecular weight sodium alginate, |
| | having an approximate molecular weight of |
| | about 18,000 (about 2 × 104 to about |
| | 1.35 × 105 Daltons) anhydrous, used as |
| | supplied (ex. FMC) |
| Protonal ® GB 1740 | sodium alginate anhydrous, used as supplied |
| | (ex. FMC) |
| ammonium acetate | solid ammonium acetate (100% active) |
| ammonia solution | aqueous NH₃ solution (29-30% wt. NH₃) |
| ammonium | aqueous NH₃ solution (29-30% wt. NH₃) |
| hydroxide (29%) | |
| acetic acid | acetic acid, 100% wt. active |
| sodium citrate | anhydrous sodium citrate, technical grade |
| | (98-100% active) |
| ammonium sulfate | anhydrous ammonium sulfate, technical |
| | grade, (98-100% active) |
| ammonium acetate | anhydrous ammonium acetate, technical |
| | grade, (98-100% active) |
| water | water from local municipal water supply |
| DI water | deionized water |

The compositions of Table 1 were produced in accordance with the following general protocol.

Measured amounts of water at room temperature (approx. 20° C.) was provided to a suitable mixing vessel, to which were subsequently added during mixing of the contents of the mixing vessel in the following sequence, copper sulfate pentahydrate or copper hydroxide, followed by the remaining constituents but for the alginate constituent. Mixing continued until all added constituents were dissolved and the aqueous composition was uniform. Subsequently the alginate constituent was slowly added during stirring until the alginate was dissolved in the composition which was present in the mixing vessel, and subsequently the formed plant treatment composition was withdrawn and could be used as mixed, but could also be diluted further prior to use, e.g., to form a tank-mix composition or other form of a treatment composition.

The foregoing compositions of Table 1 represent a concentrated form of the plant treatment compositions, which is expected to be further diluted in a suitable largely aqueous carrier to form a ready-to-use plant treatment composition for application onto plants or plant parts. It is expressly contemplated that certain or all of the example compositions, e.g. compositions E1-E7, may or are to be diluted or dispersed in a larger volume of a carrier solvent, e.g., water, and optionally also with one or more further optional constituents, e.g., chelants, surfactants, organic solvents, and thereafter applied to a plant, plant part, or crop (pre-emergent or post-emergent). For example, advantageously the foregoing E1 composition is added to a larger volume of water, to provide a ready-to-use plant treatment composition having a concentration of between about 1-2500 ppm, preferably between about 5-1000 ppm of metallic copper in the form of Cu(I) and/or Cu(II) ions which may be thereafter applied to pre-emergent or post-emergent crops, seed, plant or plant part.

An exemplary further ready-to-use plant treatment composition according to the invention formed from the following materials as previously described on Table 2 may be made according by blending together in a 1 liter beaker using a magnetic stirrer all of the constituents other than the alginate constituent, namely:

| E2 | wt % of total |
|---|---|
| DI water | 95-q.s. |
| ammonium acetate | 0.01-1 |
| copper hydroxide | 0.01-1 |
| ammonia solution | 0.01-1 |

Subsequently after the foregoing is homogenously mixed there may be to the above is then added:

| | |
|---|---|
| Manugel LBA | 0.001-2 |

and the mixture is stirred until homogeneous. The resultant composition is identified as “E2”. Advantageously the resulting copper concentration within E2 is between 50-1000 parts per million metallic copper by weight, and the pH is at least about 10. It is readily understood that the volume of the above ready-to-use E2 composition may be scaled up to provide fluid volumes in excess of 1 liter.

The following further formulations of plant treatment compositions of the invention in concentrated form adapted to be later dissolved or dispersed in a larger quantity of water to form a plant treatment composition suited for application onto seeds, plants or crops were produced according to the general protocol described with reference to E2 are described herein, wherein all constituents other than the alginate constituent were homogenously mixed to form a premix, and subsequently under stirring conditions was finally added the alginate constituent.

| | E3 | E4 | E5 |
|---|---|---|---|
| | (wt %) | (wt %) | (wt %) |
| copper hydroxide | 5.07 | 4.0 | 5.07 |
| ammonium acetate | 11.88 | 11.88 | 11.88 |
| ammonia solution | 15.6 | 15.63 | 15.60 |
| alginate (Manugel ® LBA) | 3.25 | 3.12 | 2.0 |
| DI water | 64.2 | 65.37 | 65.45 |
| viscosity | 152 cP | 68 cP | 48 cP |

All of E2-E5 had a pH of between 9.5 and 10.5 (when in a 1% w/w aqueous dilution), and were formed from the materials identified on Table 2.

The following is a further and preferred formulation of a plant treatment composition of the invention in concentrated form which is adapted to be later dissolved or dispersed in a larger volume of water to form a “ready to use” plant treatment composition suitable for application onto seeds, plants or crops.

| | E6 |
|---|---|
| | (wt. %) |
| copper hydroxide | 5.41 |
| ammonium acetate | 11.88 |
| ammonium hydroxide | 15.63 |
| alginate (Protonal GP 1740) | 3.25 |
| water, or DI water | 63.83 |

The foregoing E6 formulation exhibited a pH of 9.30 (when in a 1% w/w aqueous dilution), and were formed from the materials identified on Table 2, and were produced according to the general protocol described with reference to E2. Notably, pH buffers based on citrates are absent from the compositions.

The following is a further and particularly preferred formulation of a plant treatment composition of the invention, in which is demonstrated that an in-situ reaction between an organic base, aqueous ammonium hydroxide and an organic acid, acetic acid, is used to form ammonium acetate. An stoichiometric excess of ammonium hydroxide was initially provided, part of which was consumed by the neutralization reaction with the acetic acid which was consumed to form, in situ, ammonium acetate, with the remaining ammonium hydroxide being present in the final composition of E7.

| | starting reactants | E7 |
|---|---|---|
| | (wt %) | (wt %) |
| copper hydroxide | 5.41 | 5.41 |
| ammonium acetate | — | 11.88 |
| acetic acid | 9.3 | — |
| ammonium hydroxide | 24.73 | 15.63 |
| alginate (Protonal GP 1740) | 3.25 | 3.25 |
| water, or DI water | 57.31 | 63.83 |

The foregoing resultant E7 formulation exhibited a pH in the range of 9-10 (when in a 1% w/w aqueous dilution), and were formed from the materials identified on Table 2, and were produced generally in accordance with the general protocol described with reference to E2. Notably, pH buffers based on citrates are absent from the composition. The resultant a plant treatment composition (E7) was in a concentrated form which is adapted to be later dissolved or dispersed in a larger volume of water to form a “ready to use” plant treatment composition suitable for application onto seeds, plants or crops.

As has been stated with respect to E1, any of the further example compositions of the invention may be added to a larger volume of water, to provide a ready-to-use plant treatment composition having a concentration of between about 1-2500 ppm, preferably between about 5-1000 ppm of metallic copper in the form of Cu(I) and/or Cu(II) ions which may be thereafter applied to pre-emergent or post-emergent crops, seed, plant or plant part. It is expressly contemplated that any of the inventive compositions, as may be represented by the non-limiting example compositions E1-E7, may be, or are diluted or dispersed in a larger volume of a carrier solvent, e.g., water, and optionally also with one or more further optional constituents, e.g., chelants, surfactants, organic solvents, and thereafter applied to a plant, plant part, or crop (pre-emergent or post-emergent). It is also expressly contemplated that any of the inventive compositions, as may be represented by the non-limiting example compositions E1-E7, may be further provided as a composition, e.g., a concentrate composition which further includes one or more further optional constituents, e.g., chelants, surfactants, organic solvents, which concentrate composition is used “as is” to treat a pre-emergent or post-emergent crops, seed, plant or plant part, or which such concentrate composition is diluted or dispersed in a larger volume of a carrier solvent, e.g., water, which is thereafter used to treat a pre-emergent or post-emergent crops, seed, plant or plant part.

While the foregoing illustrate useful formulations of various plant treatment compositions in either concentrated forms, as well as in “ready to use” forms, it is nonetheless to be understood that the compositions of the invention may include metallic alginate salts based on metals other than copper. Further, the actual concentration of the sodium alginate, the copper hydroxide, the ammonium acetate and the ammonia solution can be different than those given above, and may be any which is found to be effective in order to provide a metal salt alginate as an end product. These amounts can be determined by routine experimental methods. It is expressly contemplated that the compositions may be further varied, e.g, the use of alginates having lesser or greater molecular weights; the use of alginates of two or more different types or molecular weights; the use of other metal salts other than copper, as well the use of a plurality of different metal salts, and yet fall within the teaching of the present invention.

### Plant Treatment Compositions and Testing

### (A) Phytotoxicity to Vinca

Compositions according to C1 and E1, further diluted with water to provide a plant treatment composition having a concentration of 300 ppm of metallic copper were evaluated for their phytotoxicity when applied upon Vinca in accordance with the following protocol:

Vinca plants (variety Cora) purchased from outdoor nursery brought into greenhouse, watered, fertilized and allowed to acclimate to the green house climate for 4-5 days prior to running test. Three Vinca plants were present in each 6.5 inch pot.

Plant treatment compositions of C1 and E1, namely compositions according to C1 and E1, further diluted with water to provide a plant treatment composition having a concentration of 300 ppm of metallic copper were produced and used in all later stages of the test. Plant treatment compositions of C1 and E1 were applied to the plant replicates using a ZEP Pro Sprayer (hand held model) set to deliver a spray mist.

Three plants (1 pot) represented a replicate. Plants—one pot at a time—were enclosed in a spray box and sprayed at a volume to thoroughly wet all the foliage—just prior to run-off. The spray box shielded each plant during the spraying process from other plants. The pH of each spray solution was measured with a standard laboratory pH meter prior to spraying. The pH of the E1 composition diluted to 300 ppm solution of was consistently between 9.7-9.8.

Following the application of the test plant treatment compositions, once the plants dried they were arranged in a randomized arrangement on the green house bench. Then a polyethylene drop cloth was arranged over the top of the entire bench with the top at least 15″ above the top of the plants. The edge of drop cloth extended down to the floor to enclose the entire bench. This procedure enclosed the plants in a tent for the purposes of increasing temperature and humidity. A small hose fitted with misters was situated under the green house bench to provide humidity. A recording temperature/humidity sensor was position on the bench under the tent. The sensor recorded temperature and humidity every 15 minutes. Tenting allowed the plants to subjected to humidity levels of 90%-95% and temperatures of 80-90 degrees F. during day time hours. These conditions simulated mid-summer conditions typical of the citrus growing are of central Florida.

The tent remained over the bench for 24 hours and then was removed leaving the plants in the ambient climate of the green house for the remainder of the test.

Injury ratings were taken 1, 2 and 4 days and on one occasion 7 days, post treatment, and averaged. Observations demonstrated that maximum injury was attained after 4 days. Initially, injury symptoms were recorded for flowers and leaves. These results are reported on Table 3, following, which report the injury ratings of the reading at 4 days from the Vinca leaves following application of a plant treatment composition. The injury ratings were based on visual observations by a single human observer, viewing the treated plant and the incidence of small black spots on the leaf surface. The ratings are as follows:

| Rating | Injury |
|---|---|
| 0 | no visual observation of black spots |
| 1 | Trace amount of black spots observed |
| 2 | Small proportion of black spots observed |
| 3 | Significant proportion of black spots observed |
| 4 | Large amount of black spots observed on entire plant |

The results of the testing and reported injury ratings are reported on Table 3. The foregoing test was repeated multiple times on different days to improve the overall statistical relevance of the observations.

TABLE 3

| | | Rating (Injury) |
|---|---|---|
| Test 1 | E1 (300 ppm metallic copper) | 0 |
| | C1 (300 ppm metallic copper) | 2 |
| Test 2 | E1 (300 ppm metallic copper) | 0 |
| | C1 (300 ppm metallic copper) | 4 |
| Test 3 | E1 (300 ppm metallic copper) | 0 |
| | C1 (300 ppm metallic copper) | 2 |
| Test 4 | E1 (300 ppm metallic copper) | 0 |
| | C1 (300 ppm metallic copper) | 3 |
| Test 5 | E1 (300 ppm metallic copper) | 0 |
| | C1 (300 ppm metallic copper) | 3 |

The foregoing results of Table 3 indicate that the E1 compositions based on sodium alginate, copper hydroxide, ammonia, and ammonia acetate in water, unexpectedly exhibited significantly less phytotoxicity as compared to the C1 compositions based on sodium alginate, copper sulfate, and ammonia in water.

### (B) Phytotoxicity to Citrus

Compositions according to C1 and E1, further diluted with water to provide a plant treatment composition having a concentration of 300 ppm of metallic copper were evaluated for their phytotoxicity when applied upon Citrus seedlings in accordance with the following protocol:

18 inch tall citrus seedlings, variety Valencia, one seedling to a pot, were used in the this testing. Each treatment was replicated three times, and the results from each application protocol averaged and reported. The citrus seedlings were purchased from outdoor nursery brought into greenhouse, watered, fertilized and allowed to acclimate to the green house climate for 4-5 days prior to running test.

Plant treatment compositions of C1 and E1, namely compositions according to C1 and E1, further diluted with water to provide a plant treatment composition having a concentration of 300 ppm of metallic copper were produced and used in all later stages of the test. Plant treatment compositions of C1 and E1 were applied to the plant replicates using a ZEP Pro Sprayer (hand held model) set to deliver a spray mist.

The seedlings—one pot at a time—were enclosed in a spray box and sprayed at a volume to thoroughly wet all the foliage—just prior to run-off. The spray box shielded each plant during the spraying process from other plants. The pH of each spray solution was measured with a standard laboratory pH meter prior to spraying. The pH of the E1 composition diluted to 300 ppm solution of was consistently between 9.7-9.8.

Following the application of the test plant treatment compositions, once the plants dried they were arranged in a randomized arrangement on the green house bench. Then a polyethylene drop cloth was arranged over the top of the entire bench with the top at least 15″ above the top of the plants. The edge of drop cloth extended down to the floor to enclose the entire bench. This procedure enclosed the plants in a tent for the purposes of increasing temperature and humidity. A small hose fitted with misters was situated under the green house bench to provide humidity. A recording temperature/humidity sensor was position on the bench under the tent. The sensor recorded temperature and humidity every 15 minutes. Tenting allowed the plants to subjected to humidity levels of 90%-95% and temperatures of 80-90 degrees F. during day time hours. These conditions simulated mid-summer conditions typical of the citrus growing are of central Florida.

The tent remained over the bench for 24 hours and then was removed leaving the plants in the ambient climate of the green house for the remainder of the test.

Injury ratings were taken 1, 2 and 4 days and on one occasion 7 days, post treatment, and averaged. Observations demonstrated that maximum injury was attained after 4 days. Initially, injury symptoms were recorded for flowers and leaves. These results are reported on Table 3, following, which report the injury ratings of the reading at 4 days from the seedlings following application of a plant treatment composition. The injury ratings were based on visual observations by a single human observer, viewing the treated plant and the incidence of small black spots on the leaf surface. The ratings are as follows:

| Rating | Injury |
|---|---|
| 0 | no visual observation of black spots |
| 1 | Trace amount of black spots observed |
| 2 | Small proportion of black spots observed |
| 3 | Significant proportion of black spots observed |
| 4 | Large amount of black spots observed on entire plant |

The results of the testing and reported injury ratings are reported on Table 4. The foregoing test was repeated multiple times on different days to improve the overall statistical relevance of the observations.

TABLE 4

| | | Rating (Injury) |
|---|---|---|
| Test 1 | E1 (300 ppm metallic copper) | 0 |
| | C1 (300 ppm metallic copper) | 3 |
| Test 2 | E1 (300 ppm metallic copper) | 0 |
| | C1 (300 ppm metallic copper) | 2 |

The foregoing results of Table 4 indicate that the E1 compositions based on sodium alginate, copper hydroxide, ammonia, and ammonia acetate in water, unexpectedly exhibited significantly less phytotoxicity as compared to the C1 compositions based on sodium alginate, copper sulfate, and ammonia in water.

(C) Efficacy in Control of Pseudomonas syringae on Tomato Plants

Compositions according to C1 and E1, further diluted with water to provide a plant treatment composition having a concentration of 300 ppm of metallic copper were evaluated in their efficacy in the control of bacterial speck disease on tomato plants in accordance with the following protocol:

Tomato seedlings were grown from seed in the green house. One these attained about 12-14 inches in height (about 5 weeks) they were selected for efficacy testing.

At least 8 individual plants (replications) were used per treatment.

Plant treatment compositions of C1 and E1, namely compositions according to C1 and E1, further diluted with water to provide a plant treatment composition having a concentration of 300 ppm of metallic copper were produced and used in all later stages of the test. Plant treatment compositions of C1 and E1 were applied to the plant replicates using a ZEP Pro Sprayer (hand held model) set to deliver a spray mist. The plant treatment compositions of C1 and E1 were thus applied to thoroughly wet the foliage but not to the point of run-off. The plants were allowed to thoroughly air dry for 24 hours. A series of plant replicates in each test were similarly treated only with water in order to provide ratings for untreated tomato plants, as an untreated control (“UTC”).

The treated plants were then inoculated with Pseudomonas syringae pv tomato (bacterial speck disease) by spraying the plants (small hand sprayer delivering fine mist) with a solution containing approximately 106 CFU/ml. [CFU=Colony Forming Units].

Once dry, the plants were placed in a randomized position in a growth room incubated at 30 degrees C. and 95% humidity for 48 hours and then 25 degrees C. and 65% humidity for an additional 4-7 days allowing time for full symptom expression. Disease severity was measured using a LICOR leaf meter and the results expressed as lesions per sq. cm of leaf area. The recorded results for the observed severity of the disease lesions for all 8 individual plants were averaged and reported on Table 5.

TABLE 5

| | | lesions per square |
|---|---|---|
| | | centimeter |
| Test 1 | E1 (300 ppm metallic copper) | 0.11 |
| | C1 (300 ppm metallic copper) | 0.12 |
| | UTC | 0.36 |
| Test 2 | E1 (300 ppm metallic copper) | 0.25 |
| | C1 (300 ppm metallic copper) | 0.22 |
| | UTC | 0.34 |

The foregoing results of Table 5 indicate that the E1 compositions based on sodium alginate, copper hydroxide, ammonia, and ammonia acetate in water, exhibited good control of bacterial speck disease on tomato plants.

### (D) Efficacy of Control of Bacterial Spot on Tomato Plants

A composition according to E1, (or E3 or E5) was further diluted with water to provide a number of plant treatment compositions having a concentration of 100 ppm or 300 ppm of metallic copper. Additionally a comparative composition according to C1 was diluted with water to provide a number of plant treatment compositions having a concentration of 100 ppm of metallic copper and used in the test. A further comparative example “C2” was also tested, which was a preparation of KOCIDE® 3000 (ex. E.I. DuPont de Nemours) which was formed into a plant treatment composition ultimately having 300 ppm of metallic copper. An untreated “control” sample set (“UTC”) was also present, but untreated. These foregoing compositions were evaluated in their efficacy in the control of bacterial speck disease on tomato plants in accordance with the following general protocol.

A common variety of tomato seedlings were transplanted into fine sand. The location of the test was in Florida, USA. Treatments were arranged in a randomized design with four replications. Each plot consisted of 14 plants spaced 18 in. apart within an 18 ft row with 10 ft between each plot and 6 ft between each row. A uniform guideline was followed for land preparation, fertility, irrigation, weed management and insect control during the test, the only variable being the plant treatment composition being applied. Each of the tested plant treatment compositions were applied with a high clearance sprayer designed specifically for applications in staked tomato plots at 2 mph and at 200 psi. A double drop boom equipped with six nozzles delivered a spray volume of 66 gal/acre. The tested compositions were applied at uniform intervals 8 times during the period of the test, and therafter the tomato plants were evaluated. No inoculum was necessary as bacterial infection occurred naturally.

Disease ratings were taken as disease severity (percentage symptomatic tissue). The bacterial disease ratings probably included both bacterial spot caused by Xanthomonas perforans and bacterial speck caused by Pseudomonas syringae pv. tomato. The rating did not distinguish between the two bacterial pathogens. The disease ratings were subjected to one-way ANOVA and significant differences between means were separated using LSD using SAS. Evaluation of the degree of disease rating was by a person skilled in the art approximately 2 months after the tomato seedlings were transplanted at the start of the test, and the results are indicated on the following Table 6.

TABLE 6

| | % symptomatic |
|---|---|
| | tissue |
| E1 (100 ppm metallic copper) | 10 |
| E1 (300 ppm metallic copper) | 15 |
| C1 (100 ppm metallic copper) | 8.3 |
| C2 (KOCIDE ® 3000 (300 ppm metallic copper)) | 18.3 |
| control | 38.3 |

As is seen from the foregoing reported results the plant treatment compositions based on E1 at both 100 ppm and 300 ppm dilutions exhibited excellent results when compared to the untreated control, as well as the KOCIDE® 3000 based plant treatment composition.

### (E) Efficacy of Control of Late Blight of Tomato Plants

A composition according to E1, (or E3 or E5) was further diluted with water to provide a number of plant treatment compositions having a concentration of 25 ppm, 50 ppm, 75 ppm, 150 ppm or 300 ppm of metallic copper. A further comparative example “C2” was also tested, which was a preparation of KOCIDE® 3000 (ex. E.I. DuPont de Nemours) which was formed into a plant treatment composition ultimately having 300 ppm of metallic copper. An untreated “control” sample set (“UTC”) was also present, but untreated. These foregoing compositions were evaluated in their efficacy in the control of “late blight”, viz., the incidence of Phytophtora infestans in tomato plants. The site of the test was in California, US. Four 5 ft. by 25 foot replicate test plots were used to evaluate each tested composition. The trial was initiated at the first sign of late blight (LB), Phytophthora infestans, and the compositions were applied three times at 1 day, 3 days and 7 days following the first observed incidence of “late blight”. The tested compositions were applied by a sprayer, at a delivery rate of 30 gallons/acre at 30 psi of pressure. Thereafter, the extent of the late blight was evaluated twice, one on the day of the last spray application, and a second time 7 days later. Evaluation was by a skilled evaluator; the results are indicated on Table 7.

TABLE 7

| | % disease severity | |
|---|---|---|
| | | day of last spray |
| | day of last spray | application + 7 |
| | application | days |
| E1 (25 ppm metallic copper) | 4.8 | 9.1 |
| E1 (50 ppm metallic copper) | 7.7 | 10.3 |
| E1 (75 ppm metallic copper) | 15.2 | 24.8 |
| E1 (150 ppm metallic copper) | 4.7 | 5 |
| E1 (300 ppm metallic copper) | 7.7 | 8.9 |
| C2 (KOCIDE ® 3000 | 9.8 | 13.1 |
| (300 ppm metallic copper)) | | |
| control | 21.8 | 25.6 |

No phytotoxicity was observed on foliage, flowers of fruit of the plants. As is seen from the foregoing reported results the plant treatment compositions based on E1 at all ppm dilutions exhibited excellent results when compared to the untreated control, as well as the KOCIDE® 3000 based plant treatment composition. Surprisingly the degree of control of the incidence of Phytophtora infestans in tomato plants did not vary significantly in the E1 based compositions, with excellent results reported for even the lowest concentration (25 ppm) of copper.

### (F) Efficacy of Control of Late Blight of Tomato Plants

A composition according to E1, (or E3 or E5) was further diluted with water to provide a number of plant treatment compositions having a concentration of 10 ppm, 30 ppm, 60 ppm, 90 ppm of metallic copper. Two further comparative examples “C3” and “C4” were also tested, each formed from KOCIDE® 3000 (ex. E.I. DuPont de Nemours) which was formed into a plant treatment composition ultimately having respectively 90 ppm and 270 ppm of metallic copper. All comparative compositions were made according to the label directions of their respective manufacturer and diluted in water to form a (comparative) plant treatment composition having the concentration of metallic copper as indicated below. An untreated “control” sample set (“UTC”) was also present, but untreated. These foregoing compositions were evaluated in their efficacy in the control of “late blight”, viz., the incidence of Phytophtora infestans in tomato plants. The site of the test was in California, US. Four 5 ft. by 25 foot replicate test plots were used to evaluate each tested composition. The trial was initiated at the first sign of late blight (LB), Phytophthora infestans, and the compositions were applied four times at days 1, 11, 21 and 28 days following the first observed incidence of “late blight”. The application was by a pressurized sprayer and the application rate of each of the tested compositions was 29 gallons/acre at a pressure of 40 psi. Thereafter, the extent of the late blight was evaluated twice, one on the day of the last spray application, and a second time 8 days later. Evaluation was by a skilled evaluator; the results are indicated on Table 7.

TABLE 7

| | % disease severity | |
|---|---|---|
| | | day of last spray |
| | day of last spray | application + 8 |
| | application | days |
| E1 (10 ppm metallic copper) | 0.5 | 1 |
| E1 (30 ppm metallic copper) | 0.3 | 1.5 |
| E1 (60 ppm metallic copper) | 0 | 0.3 |
| E1 (90 ppm metallic copper) | 0 | 0.3 |
| C3 (KOCIDE ® 3000 | 0.5 | 0.5 |
| (90 ppm metallic copper)) | | |
| C2 (KOCIDE ® 3000 | 0.3 | 0.8 |
| (270 ppm metallic copper)) | | |
| control | 1 | 2.8 |

No phytotoxicity was observed on foliage, flowers of fruit of the plants. As is seen from the foregoing reported results the plant treatment compositions based on E1 at all ppm dilutions exhibited excellent results when compared to the untreated control, as well as the comparative KOCIDE® 3000 based plant treatment compositions.

Surprisingly the degree of control of the incidence of Phytophtora infestans in tomato plants did not vary significantly in the E1 based compositions, with excellent results reported for even the lower concentrations of copper.

### (G) Efficacy of Control of “Fire Blight” on Apples

This trial followed the European and Mediterranean Plant Protection Organization protocol on efficacy evaluation of bactericides, 2002, OEPP/EPPO, Bulletin 32, 341-345. The test was undertaken in the State of Washington, US.

At about the time of “full bloom”, the blossoms were inoculated with the bacterial “fire blight” pathogen, Erwinia amylovora. The pathogen was a research standard strain provided by Dr. Larry Pusey, Plant Pathologist, USDA-ARS, Tree Fruit Research Laboratory, 1104 N. Western Ave., Wenatchee, Wash. 98801. Description of pathogen: Erwinia amylovora (Burr.) Winsl. et al., strain Ea 153nal. This strain was isolated in Oregon, and is susceptible to streptomycin sulfate, unlike most wild strains currently in Washington. The bacteria were cultured on nutrient agar, and then suspended in buffered water. The procedure duplicated lab standards that result in a concentration of about ten million colony forming units per ml of water. The inoculant was misted from a distance of 6 to 10 inches on about 100 flower clusters per replicate with a manually operated nonpressurized trigger spray bottles to the point where blossoms were very lightly wetted, but not completely covered. It was expected that at this concentration, when misted on blossoms in this manner, resulted in blossom cluster infection of about 30 to 60 percent in untreated checks. Weather and flower condition were optimum during the inoculation of the apples.

During the test the trees were treated with one of several treatment compositions. A composition according to E1, (or E3 or E5) was further diluted with water to provide a number of plant treatment compositions having a concentration 90 ppm and 270 ppm of metallic copper. A comparative example “C5” were also tested, which was formed from KOCIDE® 3000 (ex. E.I. DuPont de Nemours) which was formed into a plant treatment composition ultimately having 180 ppm of metallic copper. All comparative compositions were made according to the label directions of their respective manufacturer and diluted in water to form a (comparative) plant treatment composition having the concentration of metallic copper as indicated below. An untreated “control” sample set (“UTC”) was also present, but untreated. The trees were treated by the application of the foregoing compositions which were applied using an airblast sprayer, at a delivery rate of 100 gallons/acre. The application was made when the trees were at 80% bloom level and at 100% bloom level.

Trees were visually evaluated for flower cluster infections every week following treatment. Symptoms became visible about 10 days after inoculation, and continued to develop for about 28 days, after which data collection ceased. The infected flower clusters were removed at each inspection to reduce further tree damage. The numbers of blighted and unblighted blossom & fruit clusters on the marked, inoculated limbs were recorded. An uneven percentage of flower clusters “set” per replicate, therefore the number of blighted plus unblighted flower clusters varied somewhat amongst the treatments. “Percent control” was determined by dividing the percent blighted clusters in the treatment trees by the percentage of blighted clusters in the inoculated untreated check, then multiplying that number by 100, then subtracting that result from 100. Analysis of data was a One Way ANOVA, Tukey's Test, 95% confidence limits. Evaluation was by a skilled evaluator; the results are indicated on Table 8.

TABLE 8

| | % control |
|---|---|
| E1 (90 ppm metallic copper) | 72 |
| E1 (270 ppm metallic copper) | 77.5 |
| C5 (KOCIDE ® 3000 (180 ppm metallic | 61 |
| copper)) | |
| control | 0 |

### (H) Efficacy of Control of Citrus Canker

A composition according to E1, (or E3 or E5) was further diluted with water to provide a number of plant treatment compositions having a concentration of 60 ppm, and 60 ppm of metallic copper. Two further comparative examples “C6” and “C7” were also tested, each formed from KOCIDE® 3000 (ex. E.I. DuPont de Nemours) which was formed into a plant treatment composition ultimately having respectively 503 ppm and 300 ppm of metallic copper. All comparative compositions were made according to the label directions of their respective manufacturer and diluted in water to form a (comparative) plant treatment composition having the concentration of metallic copper as indicated below. An untreated “control” sample set (“UTC”) was also present, but untreated. These foregoing compositions were evaluated in their efficacy in the control of citrus canker on a citrus crop. The tested compositions were applied 8 times during a 21 day interval following the first observed incidence of the disease. Application of the treatment composition was at a rate of 125 gallons per acre; the application was made to ensure all foliage was covered. The test was in Florida, US.

Thereafter the efficacy of control of citrus canker was evaluated by ranking the degree of severity on a scale from “0” to “9” with the value of “0” representing no disease symptoms, and the value of “9” representing that 100% of the foliage was affected. The evaluation was done by a skilled evaluator; the evaluation was done once in September, and then again once in the next month October. The results of the evaluation are reported on the following Table 9; averaged results for the entire citrus crop season are also reported.

TABLE 9

| | Disease Severity (scale: 0-9) | | |
|---|---|---|---|
| | September | October | Season Average |
| E1 (60 ppm metallic copper) | 1.46 | 1.17 | 1.075 |
| E1 (90 ppm metallic copper) | 1.63 | 1.33 | 1.092 |
| C6 (KOCIDE ® 3000 (503 ppm | 0.96 | 1.04 | 0.812 |
| metallic copper)) | | | |
| C7 (KOCIDE ® 3000 (300 ppm | 1.29 | 1.04 | 0.99 |
| metallic copper)) | | | |

As is seen from the foregoing while the compositions of the invention had somewhat lesser degree of control as compared to the comparative examples, it is to be observed that the comparative compositions had a substantially higher amount of copper present.

### (I) Rainfastness of E1 Composition on Tomato Plants

The following test was performed to evaluate that perceived resistance to removal by washing off with water of the E1 composition as applied to tomato plants and subsequently subjected to contact with water at three different regimens/rates which simulated three rainfall rates. The test was also performed to compare the effects of rainfall and the resistance to removal of a plant treatment composition of the invention by washing off with water, as well as the performance of certain comparative compositions as well subjected to the same test protocol.

A composition according to E1, (or E3 or E5) was further diluted with water to provide a number of plant treatment compositions having a concentration of 30 ppm, or 90 ppm of metallic copper. Several further comparative examples “C3” and “C8” were also tested, each formed from KOCIDE® 3000 (ex. E.I. DuPont de Nemours) which was formed into a plant treatment composition ultimately having respectively 90 ppm and 1578 ppm of metallic copper. Additional comparative examples “C9” and “C10” were also formed from Cuprofix® Ultra Disperss®, a commercially available product based on copper sulfate but which excludes an alginate sold by Cerexagri-Nisso LLC, King of Prussia, Pa. (US). All comparative compositions were made according to the label directions of their respective manufacturer and diluted in water to form a (comparative) plant treatment composition having the concentration of metallic copper as indicated below. An untreated “control” sample set (“UTC”) was also present, but untreated. These foregoing compositions were evaluated in their efficacy in the control of bacterial leaf spot in tomato plants viz., the incidence of Xanthomonas vesicatoria in tomato plants (variety Lycopersicon esculentuam, commercially available as “Ace 55VF”).

The test was performed in a greenhouse. A number of replicate test plots were used to evaluate each tested composition, each test plot having an area of 280 ft². The treatment compositions based on E1 at 30 ppm or 90 ppm, as well as comparative compositions C3, C8, C9 and C10 were all applied to separate test plots at the following rates: E1 was applied at a metallic copper concentration given above. Each of the E1, C3, C8, C9 and C10 were all applied to the tomato plants at a volumetric rate of 100 ml per 5 tomato plants. At the start of the test the tomato plants were post emergent (25-30 inches high). These tested plant treatment compositions were applied once. The respective treatment compositions were applied to the respective test plots from a hand held sprayer onto the tomato plants, and allowed to dry for 24 hours prior to the initiation of any application of water at three different regimens/rates which simulated three rainfall rates. In the first simulated rainfall rate, no water was sprayed onto the treated tomato plants. In the second simulated rainfall rate, a sprayer was used to apply 0.2 litres of water/m² of the test plot over a 15 minute interval and the plants were allowed to dry. In the third simulated rainfall rate, a sprayer was used to apply 0.29 litres of water/m² of the test plot over a 15 minute interval and the plants were allowed to dry. The first, second and third simulated rainfall rates were applied to each of the test plots which had been treated with the E1, C3, C8, C9 and C10 compositions, or which were untreated “control” test plots. The plants were present in a greenhouse and in the near proximity of other tomato plants which exhibited signs of bacterial leaf spot, and as expected the tomato plants used in the test shortly exhibited signs of bacterial leaf spot as well, particularly the untreated “control” sample (“UTC”) tomato plants. At 17 days, 24 days and 32 days after treatment with the respective treatment composition the incidence of bacterial leaf spot was evaluated on each of the test plots by a skilled evaluator, and the “% severity” of the bacterial leaf spot present in each of the test plots is indicated on the following Table 10.

TABLE 10

| | 17 days | 24 days | 32 days |
|---|---|---|---|
| | after | after | after |
| | treatment | treatment | treatment |
| | % severity, first simulated rainfall rate | | |
| E1 (30 ppm metallic copper) | 3.5 | 1.8 | 4.3 |
| E1 (90 ppm metallic copper) | 3 | 1.3 | 3.3 |
| C3 (KOCIDE ® 3000, | 2.8 | 3.3 | 9.3 |
| at 90 ppm metallic copper) | | | |
| C8 (KOCIDE ® 3000, | 4 | 2 | 5.8 |
| at 1578 ppm metallic copper) | | | |
| C9 (Cuprofix ® Ultra | 3.8 | 5.5 | 11.8 |
| Disperss ®, at 90 ppm | | | |
| metallic copper) | | | |
| C10 (Cuprofix ® Ultra | 3 | 1.5 | 8.8 |
| Disperss ®, at 3605 ppm | | | |
| metallic copper) | | | |
| untreated control | 5 | 7.5 | 14.3 |
| | % severity, second simulated rainfall rate | | |
| E1 (30 ppm metallic copper) | 5 | 8.5 | 19.3 |
| E1 (90 ppm metallic copper) | 4.3 | 3.3 | 6 |
| C3 (KOCIDE ® 3000, | 2.8 | 4.8 | 12 |
| at 90 ppm metallic copper) | | | |
| C8 (KOCIDE ® 3000, | 2 | 2.8 | 9.3 |
| at 1578 ppm metallic copper) | | | |
| C9 (Cuprofix ® Ultra | 5 | 7 | 21 |
| Disperss ®, at 90 ppm | | | |
| metallic copper) | | | |
| C10 (Cuprofix ® Ultra | 2.8 | 4.8 | 7.5 |
| Disperss ®, at 3605 ppm | | | |
| metallic copper) | | | |
| untreated control | 10.3 | 10 | 24 |
| | % severity, third simulated rainfall rate | | |
| E1 (30 ppm metallic copper) | 12.3 | 12 | 21 |
| E1 (90 ppm metallic copper) | 4 | 6 | 12.5 |
| C3 (KOCIDE ® 3000, | 14.3 | 16.8 | 14.3 |
| at 90 ppm metallic copper) | | | |
| C8 (KOCIDE ® 3000, | 10.8 | 16 | 12.8 |
| at 1578 ppm metallic copper) | | | |
| C9 (Cuprofix ® Ultra | 7.5 | 16.3 | 27 |
| Disperss ®, at 90 ppm | | | |
| metallic copper) | | | |
| C10 (Cuprofix ® Ultra | 6.3 | 11.3 | 16 |
| Disperss ®, at 3605 ppm | | | |
| metallic copper) | | | |
| untreated control | 26.3 | 32.5 | 32.5 |

As is evident from the foregoing the E1 compositions provided highly effective remediation of bacterial leaf spot on the tested tomato plants, with the E1 compositions having a concentration of 90 ppm metallic copper being very effective compared to the comparative compositions which typically included much higher amounts of metallic copper.

1. Plant treatment compositions useful in the treatment of plants, particularly food crops, comprising metal alginate salts and at least one amine compound and/or ammonia as compositions, and a pH buffer composition comprising a second amine compound, wherein the amine compound is selected from the group consisting of: ammonia, a primary amine, a secondary amine and a tertiary amine compound.

2. A plant treatment compositions according to claim 1, wherein the second amine compound is ammonium acetate.

3. A plant treatment composition according to claim 1 or 2, wherein the plant treatment composition as applied to a seed, plant, plant part, or crop comprises not more than 300 ppm metallic copper.

4. A plant treatment composition according to claim 3 wherein the plant treatment composition as applied to a seed, plant, plant part, or crop comprises not more than 150 ppm metallic copper.

5. A plant treatment composition according to claim 4 wherein the plant treatment composition as applied to a seed, plant, plant part, or crop comprises not more than 100 ppm metallic copper.

6. A plant treatment composition according to claim 1, wherein the composition excludes citrates.

7. A plant treatment composition according to claim 1, wherein the composition comprises sodium acetate which is formed by an in situ reaction.

8. Plant treatment compositions according to claim 1, wherein the said compositions exclude other biologically active materials which exhibit or provide pesticidal, disease control, including fungicidal, mildew control or herbicidal or plant growth regulating effects.

9. A plant treatment compositions according to claim 1 wherein the said compositions provide plant treatment compositions are effective in the treatment of plants and for controlling the incidence and spread of bacterial spot in tomato plants, as caused by genus Xanthomonas.

10. A plant treatment compositions according to claim 1 wherein the said compositions provide plant treatment compositions are effective in the treatment of plants and for controlling the incidence and spread of bacterial speck in tomato plants, as caused by genus Pseudomonas.

11. A plant treatment compositions according to claim 1 wherein the said compositions provide plant treatment compositions are effective in the treatment of plants and for controlling the incidence and spread of late blight in tomato plants as caused by Phytophthora infestans.

12. A plant treatment compositions according to claim 1 wherein the said compositions provide plant treatment compositions are effective in the treatment of plants and for controlling the incidence and spread of citrus canker in citrus crops, as caused by genus Xanthomonas.

13. A plant treatment compositions according to claim 1 wherein the said compositions provide plant treatment compositions are effective in the treatment of plants and for controlling the incidence and spread of fire blight on pome fruit, as caused by Erwinia amylovora,

14. A method for treatment of plants in order to control the incidence of and/or spread of pathogentic fungi and bacteria and other diseases in said plants, which method comprises the application of a plant treatment composition according to claim 1 to a plant, plant part or crop.
